(19) United States
(12) Patent Application Publication
(10) Pub. No.: US 2024/0414684 A1
(43) Pub. Date: Dec. 12, 2024

(54) METHOD OF IMPROVING ACCURACY OF POSITIONING A NODE IN A CELLULAR NETWORK

(71) Applicants: CENTRE OF EXCELLENCE IN WIRELESS TECHNOLOGY, Chenna Tamil Nadu (IN); Indian Institute of Technology Madras (IIT Madras), Chennai Tamil Nadu (IN)

(72) Inventors: Vikram Singh, Chennai Tamil Nadu (IN); Abhijeet Abhimanyu Masal, Chennai Tamil Nadu (IN); Jeniston Deviraj Klutto Milleth, Chennai Tamil Nadu (IN); Bhaskar Ramamurthi, Chennai Tamil Nadu (IN)

(21) Appl. No.: 18/697,509

(22) PCT Filed: Sep. 30, 2022
(86) PCT No.: PCT/IN2022/050874

§ 371 Date: Apr. 1, 2024

(30) Foreign Application Priority Data
Oct. 1, 2021 (IN) 202141044705

(51) Int. Cl. H04W 64/00; G01S 5/02

(52) U.S. Cl. CPC H04W 64/003; G01S 5/0268

(57) ABSTRACT

The present invention relates to methods of improving accuracy of positioning a node in a cellular system. The invention discloses a method for receiving reference signal and assistance information at different antenna on each antenna port per antenna group in each time interval from antenna beams of a transmitter in a time orthogonal manner using the configuration information. The method also comprises estimation of positioning parameters based on time domain multiplexing of the at least one reference signal and the at least one assistance information received on different antenna on each antenna port per antenna group. The invention further discloses methods of improving accuracy by estimating orientation of a user equipment, shortlisting best group of measurement of positioning parameters, and optimization of time and angle window for estimation of location of the user equipment.

### PRIOR APPLICATION

The present application claims priority of PCT/IN2022/050874, filed on Sep. 30, 2022, which claims benefit from Indian Application No. 202141044705, filed on Oct. 1, 2021 and entitled “METHOD OF IMPROVING ACCURACY OF POSITIONING A NODE IN A CELLULAR NETWORK”, the disclosure of which being hereby incorporated by reference in its entirety.

### FIELD OF THE INVENTION

The present invention relates to cellular network, and more particularly to position a device in a cellular network.

### BACKGROUND OF THE INVENTION

Positioning, also called localization, is an important service in fifth generation (5G) New Radio (NR) enabling determining location of a User Equipment (UE). Positioning is necessitated in various important use-cases related to remote driving, Industry-4.0, and remote surgery. Fields like navigation and emergency services especially require positioning accuracy of a few meters for most of the UEs. On the other hand, safety critical applications demand sub meter accuracy, such as industrial internet of thing (IIoT) scenarios requires few decimeters accuracy and vehicle to everything (V2X) requires precision of position estimates up to few centimeters. 5G networks can achieve these accuracies owing to large bandwidth of reference signals, massive number of antennas at the base station (BS), dense deployments and advanced algorithms. 5G enables a device to achieve better accuracy in positioning compared to global positioning systems (GPS) especially for indoor scenarios. In turn, positioning enables the optimization of network functions such as mobility management function, beam-management, channel quality indicator (CQI) prediction and resource optimization.

The release 16 of 5G-NR support positioning methods is based on timing, angle, and power measurements. The UL-TDOA, DL-TDOA and M-RTT are time of arrival (TOA) and time difference of arrival (TDOA) based positioning methods. On the other hand, downlink angle of departure (DL-AOD) and uplink angle of arrival (UL-AOA) uses the angle of departure and angle of arrival of BS with respect to the target UE for locating the target UE. The accuracy of the timing-based methods is limited by bandwidth of the reference signal and accuracy of angle-based positioning, AOD and AOA, depends on the number of antennas at the transmitter (Tx) and receiver (Rx), respectively. The other component that affects the accuracy of the estimates is the estimation algorithms and most of the algorithms trade off precision with complexity.

FIG. 1 illustrate an architecture and interface for positioning in 5G, in accordance with prior art. The positioning of a target UE (102) is triggered based on the request made to the location management server (LMF) (104) which sits in the core network (CN) and interfaces with the NG-RAN via access and mobility function (AMF) (106). The positioning request is generated by one of the networks, target UE, or any external agent (108). The LMF (104) interacts with AMF (106) and NG-RAN via standard interfaces NLs (110) and NRPPa (-NLs-NG-C-) (112) respectively. The server terminates at UE through LPP(a) protocol which is transparent to NGRAN. The NRPPa (112) and LPP(a) enable exchange of necessary information elements between NG-RAN and UE (102), and the server (108), respectively. The 5G positioning architecture also allows positioning a target UE (102) based on ng-eNB via LPP (RRC) (114) protocol for NSA mode. The UE (102) and NG-RAN performs measurements with respect to each other over NR-Uu (116) and LTE-Uu for gNB-TRPs and ng-eNB-TPs in NSA and SA modes, respectively.

FIG. 2 illustrates the positioning procedure in 5G, in accordance with the prior art. At step 204, a LMF 202 establishes connection with the target UE via LPP and with base station via NRPPa. At step 206, the server allocates time-frequency resources to UE and BS for positioning. At step 208, a reference signal is transmitted to the receiver to perform measurement of at least one positioning parameter. The at least one positioning parameter include time based parameters such as time of arrival (ToA), angle based positioning parameters such as angle of arrival from the receiver (AoA(Rx)) and angle of departure from the transmitter (AoD(Tx)), beam-id, and orientation, power based parameter such as reference signal received power (RSRP), and mobility based parameters such as Doppler, and beam data. The measurements may be for single path (first path or line of sight path (LOS)) or multipath based. Indication for the first path or multipath based measurement may be given by either destination node or the receiver's capability. At step 210, the estimated positioning parameters are reported to a destination node in the cellular network. At step 212, assistance and additional information is reported by both the transmitter and receiver to the destination node. At step 214, the destination node performs positioning. The destination node may be any of LMF, UE and BS.

FIG. 3 illustrates a physical layer transmitter and receiver implementation for positioning, in accordance with prior art. For downlink (DL) based positioning, the LMF provides configurations to the NG-RAN for transmission (or broadcasting) of reference signals and to target UE for measuring the reference signals. Similarly, for uplink (UL) based positioning, the LMF provides resource configurations to the target UE for transmission (or broadcasting) of reference signals and to NG-RAN for measuring the reference signals. The resource configurations provided to the transmitter indicate the parameters for generation and transmission of RS signals, repetition or periodicity of RS resources, transmission filters, and transmission frequency bands etc. The resource configurations for the receiver contains one or more of RS-IDs, measurement windows, measurement gaps and frequency bands, and receive filters etc. DL-RS and UL-RS resource allocation is done according to COMB-factor and RE-offset. The COMB factor and RE-Offset allows the receiver to receive from multiple transmitters simultaneously based of the orthogonality of resources in the time and frequency domain. FIG. 4(a) illustrates DL-PRS resource allocation with COMB-12 multiplexing six base stations, in accordance with the prior art. FIG. 4(b) illustrates UL-SRS resource allocation with COMB-4, in accordance with the prior art. The resources, RS, are used by the receiver to perform the measurements required for positioning the target UE. These measurements can be one or multiple of time (difference) of arrival, angle of arrival, RS received power and angle of departure. Current standards support UL or DL-TDoA, m-RTT, UL-AoA, DL-AoD and ECID methods where the receiver estimates the position of the target UE based on one or multiple of RS time difference (RSTD), RTT, AoA, AoD and RS received power (RSRP) based on measurements reported by UE and RAN. Table 1 provided below illustrates different methods supported by release-16 standards in 5G-NR.

| Methods | UE measurements | RAN measurements | LMF |
|---|---|---|---|
| UL-TDoA | — | RSTD | Estimate position based on RSTD |
| DL-TDoA | RSTD from | — | Estimate position based on RSTD |
| | multiple BSs | | |
| m-RTT | RTT | — | Estimate position based on RTT |
| UL-AoA | — | AoA | Estimate position based on AoA |
| DL-AoD | RSRP/beam | Beam information | Estimate AoDs and use them to |
| | | | estimate the position |
| ECID | RSRP/beam | TA and B-RSRP | Estimate ToAs, AoDs and use |
| | | | them to estimate the position |

Current, transmitters and receivers are not limited by the number of antennas but by the number of antenna ports. This number of radio-frequency (RF) chains dictates number of antenna ports a device can support. Higher number of RF-chains often results in higher power consumption and increased device cost. In 5G-NR, a user equipment (UE) can support a maximum of 4 antenna ports although it can carry a lot more antennas than 4. The limited number of antenna ports at the UE restricts its ability to estimate the angle of arrival of the signals transmitted by the transmitter.

Joint estimation methods estimate multiple parameters simultaneously and generate associated parameters using unitary-ESPRIT if estimating 2 parameters and using the simultaneous Schur decomposition (SSD) method if estimating more than 2 parameters simultaneously. However, these methods are computationally complex, requires a lot of memory, transmission overhead and measurement overhead. These methods result in poor accuracy is high mobility scenarios. Individual parameter estimation is computationally simpler, has a small RS measurement and transmission overhead and requires a smaller amount of memory for implementation compared to joint estimation methods. However, it requires additional processing to find the inter-parameter association which can be a difficult task.

The limitations of MUSIC and ESPRIT methods are that it requires large number of antennas at the receiver and transmitter to estimate the angle/direction of arrival and angle/direction of departure, respectively. Theoretically, the number of antennas should be greater than or equal to the number of paths i.e., N_{tVr}>K*L, where the minimum value of K is 1 and larger the K, better is the estimation accuracy. However, in many cases, the UE cannot accommodate AAS having larger than 4×4 antenna panels. The estimation of angles is supported based on the beamforming and phase sensing abilities of the base station AASs which can accommodate from 8×8 up to 32×32 antenna arrays.

In cellular positioning, the multipath transmission or non-line of sight (NLOS) is a serious bottleneck. If a direct path is completely or partially blocked, the power of the light of sight path is low which makes the LOS path very difficult to detect in the presence of noise. A practical wireless channel has a high probability of NLOS scenario, and this probability increases with distance and scattering due to the density of the environment. In the angle of departure-based positioning technique called DL-AoD in 5G-NR, an angle of departure is estimated based on the beam transmitted from the BS and power measured by the UE. In DL-AoD, if the AoD is estimated based on the direction of maximum power received, the accuracy is limited by the number of beams transmitted and the resolution of beam transmission. A large number of transmitted beams may cause huge measurement and reporting overhead which results in high power consumption and higher latency. This technique performs poorly as the measured power contained the contributions from the NLoS paths too. Hence, it is crucial to detect the NLoS scenarios, correct them if possible and to report power corresponding to LOS path alone.

A major drawback with release-16 positioning standards is that the standards are limited in terms of performance. Another drawback with the current standards is their susceptibility to NLOS propagation. NLOS paths add bias to the angle measurements (positive or negative bias) and time measurements (positive bias) which degrades the position estimation performance. Moreover, there are other gaps in the standards such as angle measurements using uniform linear arrays is not possible.

Thus, there remains a need for accurate and efficient position estimation methods.

### OBJECTS OF THE INVENTION

A general objective of the present invention is to improve the accuracy of estimation of at least one positioning parameter.

Another objective of the invention is to reduce pilot and measurement overhead in positioning a user equipment.

Still another objective of the present invention is to fully utilize limited antennas present on the nodes in a cellular network.

### SUMMARY OF THE INVENTION

The present invention relates to methods for identifying position of a node in a wireless communication system. The method may comprise at least one first node for receiving information of the number of antennas and antenna ports available at least one second node. The at least one first node may determine at least one antenna group of at least one of the at least one first node and the at least one second node based on the number of antennas and antenna ports configured at the at least one first node and the at least one second node. The at least one first node may signal to the at least one second node, at least one of configuration information of at least one reference signal and at least one assistance information. The at least one second node may receive the at least one of configuration information of the at least one reference signal, the at least one antenna group, and the at least one assistance information transmitted by the at least one first node. The at least one first node may transmit at least one reference signal over at least one antenna group. The at least one second node may receive the at least one reference signal transmitted by the at least one first node, using the configuration information. The at least one second node may estimate at least one positioning parameter for at least one of a first arrival path and additional paths based on the at least one reference signal.

In one aspect, one of the at least one first node and the at least one second node may be a user equipment, a base station, and a relay node, in a cellular network.

In one aspect, the number of antenna groups may be given by

$$\frac{{N}_{t \vert r}}{{N}_{ap , t \vert r}} ,$$

where N_{t|r} denotes number of antennas at the at least one first node or the at least one second node, N_{ap,t} denotes number of antenna ports at the first node, and N_{ap,r} denotes number of antenna ports supported by the second node and an operator on division applied is a ceil operator.

In one aspect, the at least one reference signal may be transmitted over the at least one antenna group for the number of antenna group times in a time division multiplex manner.

In one aspect, the configuration information may include at least one of reference signal identifier and reference signal resources of at least one antenna group of the at least one first node.

In one aspect, the assistance information may include at least one of information about antenna beam, antenna array configuration information, and multiplexing information of the at least one antenna port.

In one aspect, the antenna array configuration information may include at least one of the antenna placement geometry, antenna panel information, and antenna geometry parameters.

In one aspect, the antenna placement geometry may be at least one of rectangular array, elliptical array, and cylindrical array.

In one aspect, the antenna geometry parameters for rectangular array may be at least one of vertical and horizontal spacing, number of elements per panel, number of panels in horizontal directions, number of panels in vertical direction, and polarization.

In one aspect, the antenna geometry parameters for elliptical arrays may be at least one of the radial distances and number of antenna elements across each radial direction.

In one aspect, the antenna geometry parameters for cylindrical arrays may be at least one of the radial distances, number layers and number antenna elements in each layer.

In one aspect, the at least one estimated positioning parameter may be used to estimate position of the at least one second node.

In one aspect, the at least one second node may report one of the at least one estimated positioning parameter and estimated position of the at least one second node based on the at least one positioning parameter. The reporting may be done to at least one of a location server or the at least one first node.

In one aspect, the at least one positioning parameter may comprise time positioning parameters, angle positioning parameters, mobility based parameters, and power based measurements. The time positioning parameters may include at least one of Time of Arrival (ToA) time difference of arrival (TDOA), and transmitter-receiver time difference of arrival. The angle positioning parameters may include Angle of Arrival from receiver (s-AoA) from the at least second node and Angle of Departure from the at least one first node (f-AoD). The mobility based parameters may include Doppler of at least one of the first arrival path and the additional paths. The power based measurements may include total path power corresponding to line of sight or non-line of sight paths.

In another aspect, the method for identifying position of a node in a wireless communication system may comprise receiving, by at least one first node, at least one of, an initial estimated position of a target node used for positioning and a measurement of at least one of time positioning parameter and a first angle positioning parameter from the at least one second node. The time positioning parameter may be at least one of Time of Arrival (ToA) and time difference of arrival (TDOA) and the first angle positioning parameter is Angle of Departure from the at least one first node (f-AoD). The at least one first node may receive a measurement of a second angle positioning parameter (s-AoA) from the at least one second node, wherein the second angle positioning parameter is Angle of Arrival of the at least one second node (s-AoA). The at least one first node may determine a rotation matrix using the at least one of the time positioning parameters, the first angle positioning parameters, the initial estimated position of the at least one second node, and the second angle positioning parameter. The rotation matrix may provide rotation of the at least one second node with respect to the reference for positioning at the at least one first node.

In one aspect, the at least one second node may perform a measurement of the second angle positioning parameter.

In one aspect, determining the rotation matrix by the at least one first node may comprise initializing the orientation vector with one of a rough estimate, random values, and all zero. The rotation matrix may be estimated using orientation vector. A direction vector may be estimated. The direction vector may be a difference of location estimate of the at least one second node and the location of the at least one first node. The estimated projection vector may be determined as product of distance and unit direction vector. The distance may be estimated using TOA and unit direction vector may be estimated using f-AOD estimate. The rotation matrix may be updated using retraction of previous rotation matrix estimate with weighted projection of previous rotation matrix onto the outer product of estimate of error in direction vector and local direction vector. The error in the direction vector may be difference in the estimate of the direction vector, computed using the first angle of departure and time of arrival, and dot product of previous rotation matrix and the local direction vector estimated using the second angle positioning parameter (s-AoA). The rotation matrix may be updated until a predefined criteria is satisfied.

In one aspect, the orientation vector of the at least one second node may be determined using the rotation matrix.

In one aspect, determining the orientation vector by the at least one first node may comprise initializing, the orientation vector with one of, rough estimates of value, random values, and all zero. The rotation matrix may be estimated using orientation vector. A direction vector may be estimated. The direction vector may be a difference of location estimate of the target node and the location of the at least one first node. An estimated projection vector may be determined as a product of distance and the unit direction vector. The distance may be estimated using TOA estimate and the unit direction vector may be estimated using f-AOD. The orientation vector may be updated using gradient of the difference of the estimated projection vector and measured projection vector. The measured projection vector may be the product of the rotation matrix estimate and the direction vector estimate. The orientation vector may be updated until a predefined criteria is satisfied.

In one aspect, one of the at least one first node and the at least on second node may include at least one of a user equipment, base station, and a relay node.

In one aspect, a value of the measurement of the second angle positioning parameter (s-AoA) may be a function of a local co-ordinate system.

In one aspect, a value of the measurement of the first angle positioning parameter (f-AoD) and the time positioning parameter, may be a function of a global co-ordinate system.

In one aspect, the initial estimated position of the at least one second node may be reported along with at least one of an integrity and a time stamp of measurement.

In another aspect, a method for identifying position of a node in a wireless communication system may comprise receiving, by the at least one first node, a measurement of at least one positioning parameter from an at least one second node. The at least one first node may group at least one positioning parameter in a permutation manner. The at least one first node may be calculate an estimated position of the at least one second node based on each group of the at least one positioning parameter. The at least one first node may calculate an optimization error in an estimated position of the at least one second node over each group of the at least one positioning parameter. The group of the at least one positioning parameter with a minimum optimization error may be selected as best group of positioning parameters for estimating position.

In one aspect, the at least one positioning parameter may comprise time positioning parameters, angle positioning parameters, mobility based parameters, and power based measurements. The time positioning parameters may include at least one of Time of Arrival (ToA), Time Difference of Arrival (TDOA) and transmitter-receiver time difference of arrival for one or multiple paths. The angle positioning parameters may include at least one of the Angle of Arrival from second node (s-AoA) and Angle of Departure from the first node (f-AoD) for one or multiple paths. The mobility based parameters may include Doppler of at least one of the first arrival path and additional paths. The power based measurements may include total path power corresponding to line of sight or non-line of sight paths.

In one aspect, the one of at least one first node and the at least one second node may be one of a user equipment, base station and a relay node in a cellular network.

In one aspect, the configuration information may include at least one of reference signal identifier and time-frequency resources of reference signal of the at least one second node.

In one aspect, the measurement of the at least one positioning parameters may include measurement of the at least one positioning parameter indexed by a corresponding identifier of the at least one of, the at least one first node, and the second node.

In one aspect, each group of measurement of positioning parameters may include tuples of the at least one positioning parameters indexed by a corresponding identifier of at least one of the at least one second node and the at least one first node.

In one aspect, a method for identifying position of a node in a wireless communication system, may comprise receiving, by an at least one second node, configuration information of an at least one reference signal and an at least one assistance information. The at least one second node may perform a measurement of an at least one positioning parameter based on the configuration information from the at least one first node. The at least one second node may group at least one positioning parameter in a permutation manner. The at least one second node may calculate an estimated position based on each group of the at least one positioning parameter. The at least one second node may calculate an optimization error in an estimated position over each group of the at least one positioning parameter. A group of the at least one positioning parameter with a minimum optimization error may be selected as a best group of positioning parameters for estimating the position.

In one aspect, the at least one second node may position using the measurements of group of measurement selected as the best group of at least one positioning parameter. Further, the at least one second node may report measurements of positioning parameters to the at least one first nodes for selecting the best group of at least one positioning parameter for performing one of the positioning of the at least one second node or reporting the measurements of the best group of at least one positioning parameter to another node in the wireless network. Further, the at least one second node may report the measurement selected as the best group of positioning measurements may be reported.

In one aspect, the measurement of the at least one positioning parameters in each group may be reported in a relative manner after performing mathematical operation on measurements to reduce overhead in reporting.

In one aspect, the mathematical operation may be one of subtraction, addition, division, power, and multiplication of the at least one measurement with one of maximum, mean, median, mode, and minimum of the at least one measurement.

In one aspect, the at least one positioning parameter may comprise time positioning parameters, angle positioning parameters, mobility based parameters, and power based measurements. The time positioning parameters may include at least one of Time of Arrival (ToA), Time Difference of Arrival (TDOA) and transmitter-receiver time difference of arrival for one or multiple paths. The angle positioning parameters may include at least one of the Angle of Arrival from second node (s-AoA) and Angle of Departure from the first node (f-AoD) for one or multiple paths. The mobility based parameters may include Doppler of at least one of the first arrival path and additional paths. The power based measurements may include total path power corresponding to line of sight or non-line of sight paths.

In one aspect, the at least one first node and the at least one second node may be one of a user equipment, base station and a relay node in a cellular network.

In one aspect, the configuration information may include at least one of a reference signal identifier and time-frequency resources of a reference signal of the at least one second node.

In one aspect, the measurement of the at least one positioning parameters may include measurement of the at least one positioning parameter indexed by a corresponding identifier of the at least one of, the at least one first node, and the second node.

In one aspect, each group of measurement of positioning parameters may include tuples of the at least one positioning parameters indexed by a corresponding identifier of at least one of the at least one second node and the at least one first node.

In one aspect, a method for identifying position of a node in a wireless communication system may comprise reporting, by at least one second node, measurement of at least one positioning parameter to at least one first node. One of the at least one first node and the at least one second node may calculate at least one of an average and a standard deviation of measurement of the at least one positioning parameter. One of the at least one first node and the at least one second node may determine a measurement window for the at least one second node using at least one of the average and the standard deviation of the measurement of the at least one positioning parameters.

In one aspect, the standard deviation may be scaled by a predefined positive value.

In one aspect, determining the measurement window may comprise configuring, by the at least one first node, the measurement window for estimating position of the at least one second node. The at least one second node may be expected to receive at least one reference signal for determining the at least one positioning parameter.

In one aspect, the measurement window may be at least one of time window and angle window based on the at least one positioning parameter and the estimated position.

In one aspect, the at least one positioning parameter comprises time positioning parameters, angle positioning parameters, mobility based parameters, and power based measurements. The time positioning parameters may include at least one of Time of Arrival (ToA), Time Difference of Arrival (TDOA), and transmitter-receiver time difference of arrival. The angle positioning parameters may include Angle of Arrival (s-AoA) from the at least second node and Angle of Departure from the at least one first node (f-AoD). The mobility based parameters may include Doppler of at least one of the first arrival path and the additional paths. The power based measurements may include total path power corresponding to line of sight or non-line of sight paths.

In one aspect, measurement window may be determined with information on the at least one of ToA estimates, s-AoA estimates, f-AoD estimates, and cell geometry information including cell radius and cell boundary geolocation.

In one aspect, the measurement window may be signalled to one of, the at least one first node and the at least one second node.

In one aspect, the at least one first node and the at least one second node may be one of a user equipment, base station, and a relay node, in a cellular network.

In one aspect, the at least one first node may use angle (AoD) measurement windows for transmit beamforming.

In one aspect, the at least one second may use the angle (AoA) measurement windows for receiver beamforming and receiver filtering, and time measurement windows for reserving resources for reference signal reception.

In one aspect, the configuration information may include at least one of reference signal identifier and time-frequency resource of reference signal of the first node.

In one aspect, calculating the standard deviation of the measurement of the at least one positioning parameter may further comprise estimating the integrity of measurement of the at least one positioning parameter using a first predefined function of the measurement error in at least one positioning parameter of the at least one second node, and calculating a value in a range of 0 to 1 using a second predefined function.

In one aspect, the first predefined function may be one of the maximum, minimum, mean, median, mode and weighted mean.

In one aspect, the second predefined function may be one of sigmoid function and hyperbolic tangent function.

In another aspect, a method for identifying position of a node in a wireless communication system may comprise receiving a configuration by at least one second node, a reference signal for reporting at least one positioning parameter for a plurality of paths to a at least one first node. The at least one second node may receive the reference signal for reporting the at least one positioning parameter for a plurality of paths. The at least one second node may estimate positioning parameters for the plurality of paths using the received reference signal. The at least one second node may report at least one path positioning parameter to the at least one first node. The at least one path positioning parameter may be one of path delay, path angle, path Doppler, path phase and path power.

In one aspect, the path power may be defined as an absolute value of the sum of the product of channel at subcarrier with an exponential function of subcarrier spacing and path delay.

In one aspect, a path of the plurality of paths may be a trajectory followed by the transmitted signal while propagating over wireless channel before reaching the receiver.

In one aspect, the at least one positioning parameters may include at least one of the time positioning parameters, angle positioning parameters, mobility based parameters, and power based measurements. The time positioning parameters may include at least one of Time of Arrival (ToA), Time Difference of Arrival (TDOA), and transmitter-receiver time difference of arrival. The angle positioning parameters may include Angle of Arrival (s-AoA) from the at least second node and Angle of Departure from the at least one first node (f-AoD). The mobility based parameters may include Doppler of at least one of the first arrival path and the additional paths. The power based measurements may include total path power corresponding to line of sight or non-line of sight paths, and orientation of the target node, for each of the plurality of paths.

In one aspect, the at least one first node and at least one second node may be one of a user equipment, a base station, and a relay node, in a cellular network.

In one aspect, a number of the plurality of paths may be signaled to the at least one first node by the at least one second node or indicated by least one first node.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates an architecture and interface for positioning a user equipment (UE) in 5G, in accordance with prior art.

FIG. 2 illustrates the positioning procedure in 5G, in accordance with the prior art.

FIG. 3 illustrates a physical layer transmitter and receiver implementation for positioning, in accordance with the prior art.

FIG. 4(a) and FIG. 4(b) illustrates DL-PRS resource allocation with COMB-12 multiplexing six base stations and UL-SRS resource allocation with COMB-4 respectively, in accordance with prior art.

FIG. 5 illustrates antenna port multiplexing across time, in an embodiment of the present invention.

FIG. 6 illustrates a method of utilising dynamic port mapping, in accordance with an embodiment of the present invention.

FIG. 7 illustrates signaling procedure for enabling port multiplexing based reception and transmission where the location server provides assistance data and estimates the position for DL based positioning methods, in accordance with an embodiment of the present invention.

FIG. 8 illustrates the signaling procedure for enabling port multiplexing based reception and transmission where location server provides the assistance data and UE estimates the position for DL based positioning methods, in accordance with an embodiment of the present invention.

FIG. 9 illustrates the signaling procedure for enabling port multiplexing based reception and transmission where base station provides the assistance data and UE estimates the position for DL based positioning methods, in accordance with an embodiment of the present invention.

FIG. 10 illustrates the signaling procedure for enabling port multiplexing based reception and transmission where base station provides the assistance data and UE estimates the position for DL based positioning methods, in accordance with an embodiment of the present invention.

FIG. 11 illustrates a flow chart depicting a method of orientation estimation, in accordance with an embodiment of the present invention.

FIG. 12(a) illustrates an algorithm for selection of N accurate measurements out of total M measurements from M BSs based on a minimum least square iterative procedure, and FIG. 12(b) illustrates a method for selection of group of accurate measurements, in accordance with an embodiment of the present invention.

FIG. 13 illustrates a flowchart of a method of optimizing the measurement window of a target node where the target node expects to receive one or more reference signal for determining positioning parameters, in accordance with an embodiment of the present invention.

FIG. 14 illustrates the calculation of time and angle windows for reception and transmission of reception signals, in accordance with an embodiment of the present invention.

FIG. 15 illustrates a method of integrity estimation, in accordance with an embodiment of the present invention.

FIG. 16 illustrates Joint estimation of AoA, AoD and ToA using neural network based models, in accordance with an embodiment of the present invention.

FIG. 17 illustrates estimation of two measurements out of AoA, AoD and ToA using neural network based models, in accordance with an embodiment of the present invention.

FIG. 18 illustrates individual estimation of AoA, AoD and ToA using neural network based models, in accordance with an embodiment of the present invention.

FIG. 19 illustrates a high accuracy method for measurement of inter-parameter association, in accordance with an embodiment of the present invention.

FIG. 20(a) illustrates an overall method of input of positioning parameters for estimation of association between the measurement of one or more positioning parameters, and FIG. 20(b) illustrates describes detailed method A (denoted by method (19(i)) previously) and method B denoted by method (19(ii)) previously), in accordance with an embodiment of the present invention.

FIG. 21 illustrates a method for reporting measurement of positioning parameters of multipath, in accordance with an embodiment of the present invention.

FIG. 22(a) illustrates a power delay profile of a channel between transmitter (with 64 antennas) and receiver (with 1 antenna) for Indoor factory-sparse high scenarios, and FIG. 22(b) illustrates a low complexity method of estimation of positioning parameters (ToA and AoD) based on beam direction, in accordance with an embodiment of the present invention.

FIG. 23 illustrates the low complexity method of estimation of positioning parameters (ToA and AoD) based on channel estimation, in accordance with an embodiment of the present invention.

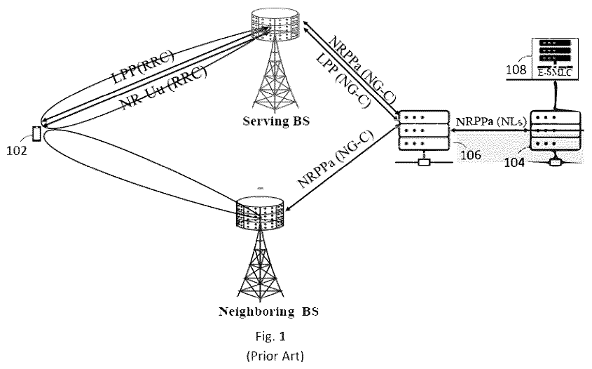

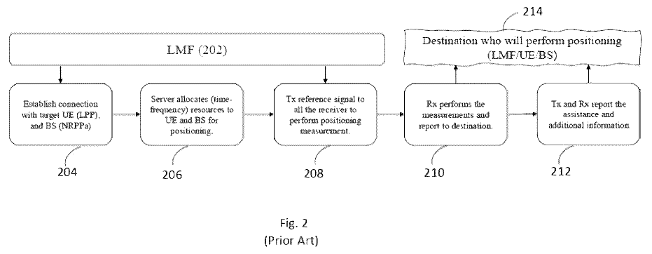

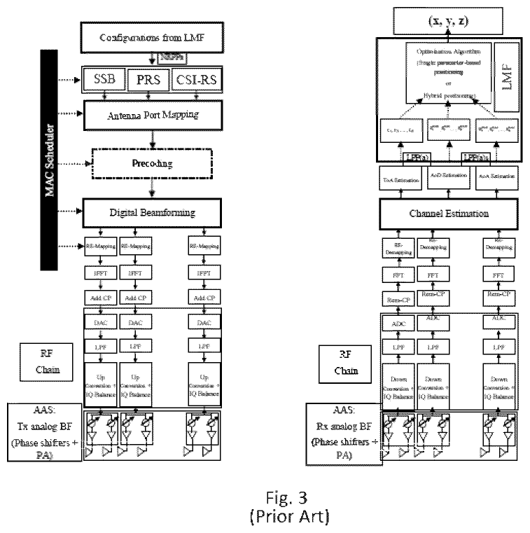

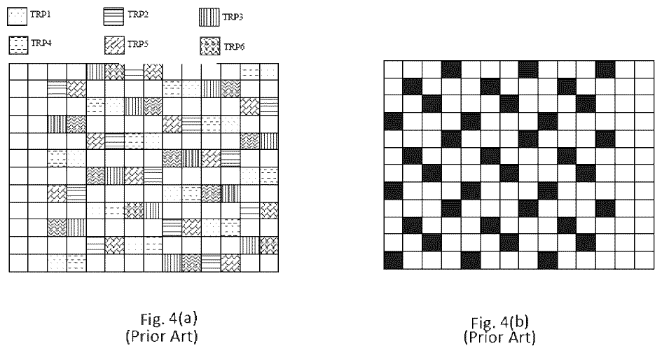

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

At several places throughout the description provided henceforth, a single type of node for example, a receiver has been described to perform an entire method. It must be noted that the receiver may be a User Equipment (UE), a base station, a positioning server, relay node, vehicle-to-everything (V2X) node, transmission reception points (TRP), or repeaters. Similarly, a transmitter may be any device of any capability such as a base station, a relay, another UE etc. The receiver and the transmitter may be one of a serving node, neighboring node, primary node, and secondary node. The transmitter and the receiver may perform all steps or certain of the method, individually or cumulatively.

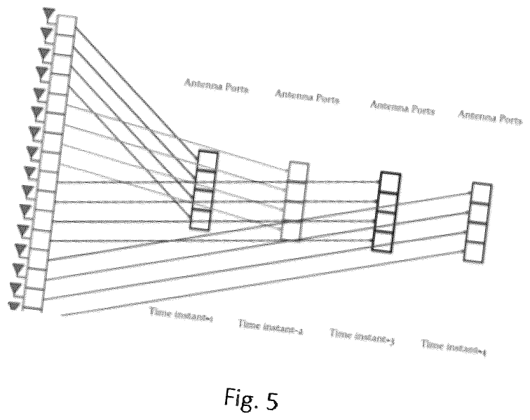

The present invention relates to method of improving accuracy of positioning a node in a cellular network. FIG. 5 illustrates antenna port multiplexing across time, in an embodiment of the present invention. As illustrated in FIG. 5, a receiver having 16 different antennas elements but supporting only 4 antenna ports may be considered. Reference signals from all the antennas may be received by connecting these antenna ports to different antenna elements in each time instant by repeating the transmission of reference signals. The repetition may not be necessary periodic or continuous. The repetition of the resources may be configured by one or more of the transmitter, receiver or a central entity such as a location server. A minimum number of times that a transmitter or receiver transmits or receives the reference signal (RS), or pilots to exploit the whole space diversity is equal to number of antenna groups for the receiver.

Number of antenna

$$groups = \frac{{N}_{t \vert r}}{{N}_{ap , t \vert r}}$$

where N_{t|r} denotes number of antennas at the transmitter/receiver, N_{ap,t} denotes number of antenna ports at the transmitter, and N_{ap,r} denotes number of antenna ports supported by the receiver and an operator on division applied is a ceil operator. In case the network may wish to exploit the full spatial diversity at both the transmitter and receiver side, the same procedure may be repeated at both sides with minimum antenna groups equal to

$$\frac{{N}_{t \vert r}}{{N}_{ap , t}} \times \frac{{N}_{t \vert r}}{{N}_{ap , r}} .$$

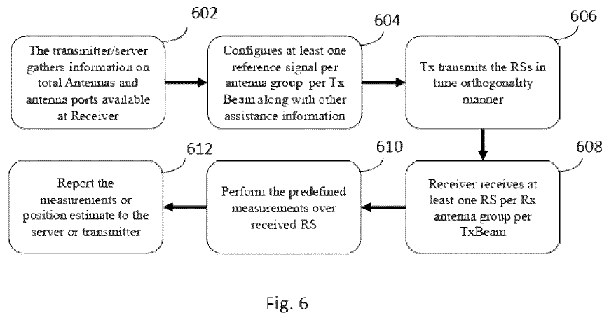

FIG. 6 illustrates a method of utilising dynamic port mapping, in accordance with an embodiment of the present invention. The method may utilize multiplexing antenna ports at a UE across time. Different antennae in each time interval may be used to receive reference signals as the UE may request base station to transmit or repeat the reference signal across time. At step 602, a transmitter may receive information on number of antennas and antenna ports available at a receiver. The transmitter may determine the number of antenna groups for the receiver. At step 604, the receiver may request configuration information of at least one reference signal and at least one assistance information of each antenna port or per antenna group of the receiver across time. The assistance information may be provided by either a base station to the UE or by Location Management Function (LMF) to all the base stations and UEs. The configuration information may include one or more of reference signal identifiers, and reference signal resources at the different antennae on each antenna port of the second node. Further, the assistance information may include one or more of information about antenna beams, antenna array configuration, and port multiplexing information. The antenna beam information may include beam information such as Discrete Fourier Transform (DFT) beam. The antenna array configuration information includes antenna placement geometry, antenna panel information, and antenna geometry parameters such as inter-element spacing i.e., vertical and horizontal spacing in case of rectangular arrays, and radial distances for elliptical arrays. The antenna array configuration may further include information about the number of antennas based on geometry, for example, the number of the antenna along the horizontal and vertical direction in the case of rectangular arrays. The antenna geometry parameters for rectangular array may be at least one of the one of vertical and horizontal spacing, number of elements per panel, number of panels in horizontal directions, number of panels in vertical direction, and polarization. The antenna geometry parameter for elliptical arrays may be at least one of the radial distances and number of antenna elements across each radial direction. The antenna geometry parameter for cylindrical arrays may be at least one of the radial distances, number layers and number antenna elements in each layer. Port multiplexing information may include ports to reference signal-identifier mapping, port multiplexing information, and port to antenna array configuration information.

At step 606, the transmitter may use configuration information to transmit antenna beams in a time orthogonal manner for transmitting at least one reference signal and at least one assistance information. At step 608, the receiver may receive at least one reference signal and at least one assistance information at a different antenna on each antenna port per antenna group in each time interval. At step 610, the transmitter may estimate at least one positioning parameter for at least one of a first arrival path and additional paths based on time domain multiplexing of at least one reference signal and the at least one assistance information received on the different antenna on each antenna port per antenna group. Path in the first arrival path and additional paths indicates a trajectory followed by the transmitted signal while propagating over the channel before reaching to the receiver. The receiver may perform predefined measurements over the received reference signal to estimate the positioning parameters. At step 612, wherein the at least one receiver may report one of estimated values of the at least one positioning parameter or the position of the receiver based on the at least one positioning parameter to the transmitter. The estimated values of the positioning parameters may also be reported by the receiver to a location server. The location server may be one of a central entity and a server with the assistance information required for positioning the receiver.

In one embodiment, the receiver may estimate positioning parameters of the UE using estimation of signal parameters via rotational invariance technique (ESPRIT) and multiple signal classification (MUSIC). The positioning parameters may be estimated individually and jointly based on the reporting required. The at least one positioning parameter may comprise time positioning parameters, angle positioning parameters, and mobility based parameters. The time positioning parameters includes Time of Arrival (ToA) and Time Difference of Arrival (TDoA), the angle positioning parameters include Angle of Arrival from receiver (rx-AoA), Angle of Departure from transmitter (tx-AoD), and the mobility based parameters include Doppler of at least one of the first arrival path and additional paths.

In another embodiment, the transmitter may be configured to repeat either the same or different reference signals on same time-frequency resources with same transmit beam and receive beam. The procedure may be repeated for all the transmit beams and receive beams to achieve better angle and time measurement estimation accuracy. Resources may be repeated for port multiplexing only for beams that are more likely to be line-of-sight (LoS). Such repetition of resources may reduce transmission and measurement overhead. The repetition factor is allowed to take a minimum value of 1 for high capability receivers and larger value based on one of the number of ports supported, number of antennas at the receiver and required accuracy performance.

The method of utilising dynamic port mapping as illustrated in FIG. 6 is not limited to just the above-stated methods and is easily extendable to other methods such as channel impulse response (CIR) based estimation of one or multiple of ToA, AoA and AoD at the transmitter or receiver. The above-described method may further be utilised in both uplink and downlink transmission.

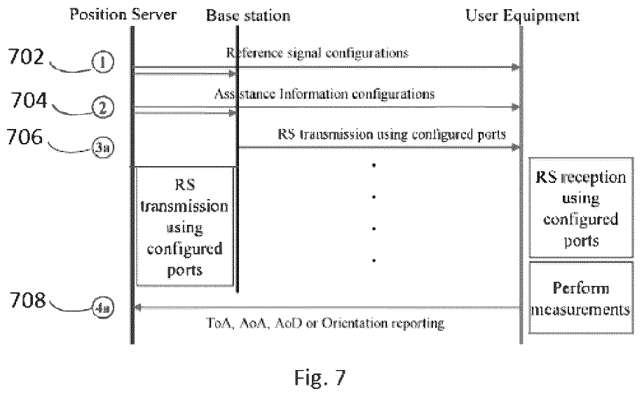

FIG. 7 illustrates signaling procedure for enabling port multiplexing-based reception and transmission where the location server provides assistance data and estimates the position for DL based positioning methods. At step 702 (denoted by 1), a positioning server may send reference signal configuration to a base station and a UE. At step 704 (denoted by 2), the positioning server may send assistance information to the base station and the UE. At step 706 (denoted by 3a), the base station may transmit reference signals using each configured antenna port per antenna group based on at least one of the configuration information and the assistance information. The UE may receive the reference signals using configured antenna ports based on at least one of the configuration information and the assistance information. At step 708 (denoted by 4a), the UE may perform measurements of the positioning parameters of the UE such as one or more of ToA, AoA, AoD, and orientation. The measured positioning parameters may be reported to the positioning server by the UE. The positioning server may estimate the location of the UE based on the positioning parameters.

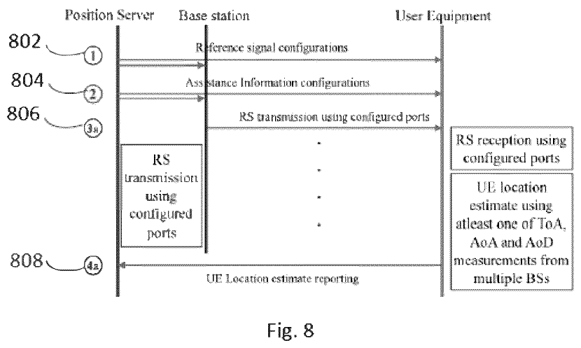

FIG. 8 illustrates signaling procedure for enabling port multiplexing based reception and transmission where location server provides the assistance data and UE estimates the position for DL based positioning methods. At step 802 (denoted by 1), a positioning server may send reference signal configuration to a base station and a UE. At step 804 (denoted by 2) the positioning server may send assistance information to the base station and the UE. At step 806 (denoted by 3a), the base station may transmit reference signals using configured antenna ports based on at least one of the configuration information and the assistance information. The UE may receive the reference signals using each configured antenna port per antenna group based on at least one of the configuration information and the assistance information. At step 808 (denoted by 4a), the UE may perform measurements of the positioning parameters of the UE such as one or more of ToA, AoA, AoD, and orientation. The UE may estimate the location of the UE based on a positioning method and report the location estimate to the positioning server.

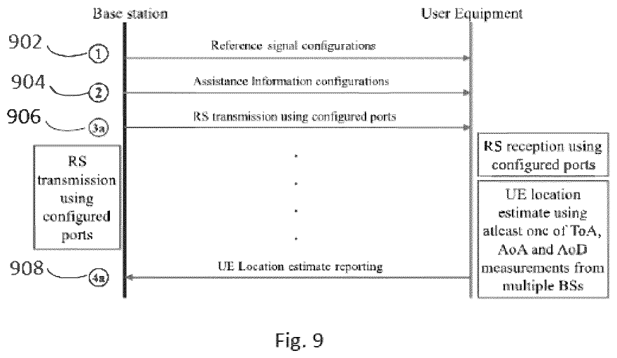

FIG. 9 illustrates signaling procedure for enabling port multiplexing based reception and transmission where base station provides the assistance data and UE estimates the position for DL based positioning methods. At step 902 (denoted by 1), a base station may send reference signal configuration to a UE. At step 904 (denoted by 2), the base station may send assistance information to the UE. At step 906 (denoted by 3a), the base station may transmit reference signals using configured antenna ports based on at least one of the configuration information and the assistance information. The UE may receive the reference signals using each configured antenna port per antenna group based on at least one of the configuration information and the assistance information. At step 908 (denoted by 4a), UE may perform measurements of the positioning parameters of the UE such as one or more of ToA, AoA, AoD, and orientation. The UE may estimate the location of the UE based on a positioning method and report the location estimate to the positioning server.

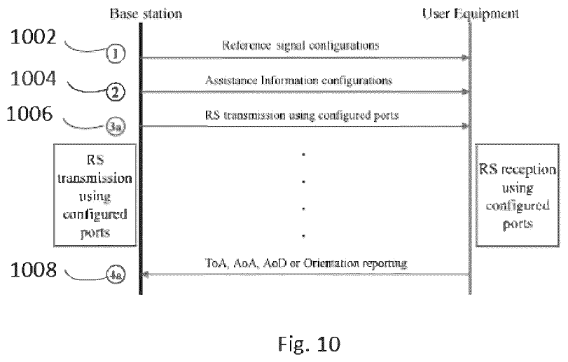

FIG. 10 illustrates signaling procedure for enabling port multiplexing based reception and transmission where base station provides the assistance data and UE performs measurements of the positioning parameters such as one or more of ToA, AoA, AoD, and orientation. At step 1002 (denoted by 1), a base station may send reference signal configuration to a UE. At step 1004 (denoted by 2), the base station may send assistance information to the UE. At step 1006 (denoted by 3a), the base station may transmit reference signals using each configured antenna port per antenna group based on at least one of the configuration information and the assistance information. The UE may receive the reference signals using configured antenna ports based on at least one of the configuration information and the assistance information. At step 1008 (denoted by 4a), the UE may report the positioning parameters of the UE to the base station, such as one or more of ToA, AoA, AoD, and orientation. The base station may estimate the location of the UE based on the positioning parameters and positioning method.

In another embodiment, the orientation of the node may be used to estimate angle positioning parameters with respect to the global coordinates system for improving the accuracy of positioning a node in the cellular network communication system. Positioning parameters such as Angle of Arrival from the transmitter (tx-AoA), Angle of Departure from the receiver (rx-AoD), and Time of Arrival (ToA) may be used to first detect the state of the link of transmission. The state of the link may be one of a Line of Sight (LoS) path and a Non-Line of Sight (NLoS) path. Based on the state of the link, the position of the UE may be estimated based on the most accurate measurements of the positioning parameters. The alignment of Angle of Departure from transmitter (tx-AoD) and the Angle of Arrival from receiver (Rx-AoA) indicates that the link is LoS. However, the orientation of the UE rotates the UE-AoA deeming the AoA estimates useless. Hence, the orientation estimation, O=[α, β, γ], or a rotation matrix (R), becomes extremely crucial to estimate the AoA with respect to global co-ordinates system.

The rotation matrix (R) is a 3×3 unitary matrix defined as follows:

$${R}_{z} ( α ) {R}_{y} ( β ) {R}_{x} ( γ )$$

$${R}_{z} ( α ) = [ \begin{matrix}cos ( α ) & - sin ( α ) & 0 \\ sin ( α ) & cos ( α ) & 0 \\ 0 & 0 & 1\end{matrix} ] ;$$

$${R}_{y} ( β ) = [ \begin{matrix}cos ( β ) & 0 & sin ( β ) \\ 0 & 1 & 0 \\ - sin ( β ) & 0 & cos ( β )\end{matrix} ] ;$$

$${R}_{x} ( γ ) = [ \begin{matrix}1 & 0 & 0 \\ 0 & cos ( γ ) & - sin ( γ ) \\ 0 & sin ( γ ) & cos ( γ )\end{matrix} ]$$

and the direction vector [symbol] of the UE with respect to the BS-m are be related by a first equation:

$${q}_{m} = R * {\overleftarrow{d}}_{m}$$

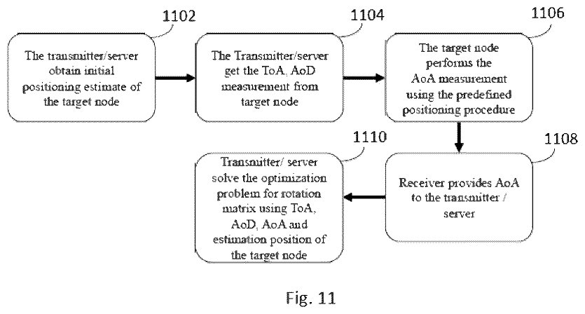

FIG. 11 illustrates a flow chart depicting a method of orientation estimation, in accordance with an embodiment of the present invention. At step 1102, the transmitter may receive an initial estimated position of a target node relative to a reference used for positioning at the transmitter. The initial estimated position of the target node may be provided along with the integrity and time stamp of the measurement for shortlisting. The transmitter location may also be provided by the target node along with the integrity and time stamp of the measurement for shortlisting. The integrity and time stamp of the measurement is relevant where the location of the transmitter is not fixed. The target node may be one or more of a user equipment, a primary base station, a serving base station, an anchor node, an assisting node, and a location node. At step 1104, the transmitter may receive a measurement of a Time of Arrival (ToA) and Angle of Departure from the transmitter (tx-AoD) from the target node. The measurement of the tx-AoD may be provided in GCS along with the integrity and time stamp of the measurement. The measurement of the ToA may be provided in GCS along with the integrity and time stamp of the measurement.

The estimate [symbol] is calculated either using the position estimate of the UE (\hat{p}) and the BS-m (pₘ)

$${\hat{d}}_{m} = \hat{p} - {p}_{m}$$

using the ToA estimate τₘ and BS-AoD (θₘ^{AoD}, Øₘ^{AoD}) estimate as follows

$${\hat{d}}_{m} = c * {τ}_{m} * [ \begin{matrix}cos ( {ϕ}_{m}^{AoD} ) * sin ( {θ}_{m}^{AoD} ) \\ sin ( {ϕ}_{m}^{AoD} ) * sin ( {θ}_{m}^{AoD} ) \\ cos ( {θ}_{m}^{AoD} )\end{matrix} ] .$$

The receiver estimates the AoA which is rotated by the UE orientation given by (\tilde{θ}ₘ^{AoD}, \tilde{Ø}ₘ^{AoD}).

The AoA estimates are in the local co-ordinate system (LCS). The mapping from GCS to LCS is given by R. The estimate of direction vectors in LCS is given by

$${\hat{q}}_{m} = c * {τ}_{m} * [ \begin{matrix}cos ( {\tilde{ϕ}}_{m}^{AoA} ) * sin ( {\tilde{θ}}_{m}^{AoA} ) \\ sin ( {\tilde{ϕ}}_{m}^{AoA} ) * sin ( {\tilde{θ}}_{m}^{AoA} ) \\ cos ( {\tilde{θ}}_{m}^{AoA} )\end{matrix} ] .$$

At step 1108, the transmitter may receive a measurement of the Angle of Arrival from the receiver (rx-AoA) from the target node. At step 1110, the transmitter may determine a rotation matrix using the ToA, Tx-AoD, Rx-AoA, and the initial estimated position of the target node. The rotation matrix may provide rotation of the target node with respect to the reference for positioning at the transmitter. The rotation matrix may be used to determine an optimization vector of the target node.

Based on the estimate of local and global direction vectors with respect to all the transmitters/base stations, the LCS to GCS mapping or rotation matrix is estimated as follows

$$\hat{R} = {min}_{R} {\sum }_{m = 1}^{M} {‖ {\hat{q}}_{m} - R * {\hat{d}}_{m} ‖}^{2}$$

$$Subject to {R}^{T} R = I 3$$

Note that the rotation matrix, R is a 3×3 unitary matrix. The rotation matrix, R, cannot be estimated using conventional gradient descent or Newton Raphson algorithm. To maintain the unitary property of R in each iteration the optimization is performed based on retraction and projection operators as shown below:

$${\hat{R}}_{i} = Retraction ( {\hat{R}}_{i - 1} , - {ε}_{i} * Projection ( {\hat{R}}_{i - 1} , {\sum }_{m = 1}^{M} ( {\hat{q}}_{m} - {\hat{R}}_{i - 1} * {\hat{d}}_{m} ) * {\hat{d}}_{m}^{T} ) ) where$$

$$Retraction ( A , B ) = ( A + B ) * {( {I}_{3} + {B}^{T} B )}^{- \frac{1}{2}}$$

$$Projection ( A , B ) = B * \frac{( {A}^{T} B - {B}^{T} A )}{Z} and ,$$

$$\vert {ε}_{i} \vert < 1.$$

Each iteration is written as closed form

$${\hat{R}}_{i} = Retraction ( {\hat{R}}_{i - 1} , - {ε}_{i} * Projection ( {\hat{R}}_{i - 1} , ( Q - {\hat{R}}_{i - 1} * D ) * {D}^{T} ) ) , where$$

$$Q = [ \begin{matrix}{\hat{q}}_{1} & {\hat{q}}_{2} & … & {\hat{q}}_{M}\end{matrix} ] ;$$

$$D = [ \begin{matrix}{\hat{d}}_{1} & {\hat{d}}_{2} & … & {\hat{d}}_{M}\end{matrix} ] ;$$

In one embodiment, to improve the convergence of the gradient descent or the Newton Raphson method, the initialization of R is chosen to be a random unitary matrix. The decrease in the step size, εᵢ, with iteration results in better convergence compared to constant step size. However, a small step size ˜10⁻⁴ provides accurate results

Similarly, instead of the rotation matrix, it is possible to directly solve for orientation vector o itself as follows:

$$δ = {min}_{o} {\sum }_{m = 1}^{M} {‖ {\hat{q}}_{m} - R ( o ) * {\hat{r}}_{m} ‖}^{2}$$

$$Subject to \vert o ( i ) \vert < \frac{π}{2} for i = 1 , 2 and 3.$$

This optimization problem is solved as follows,

$${\hat{o}}_{i} = {\hat{o}}_{i - 1} - {ε}_{i} * {∇}_{o} ( {\sum }_{m = 1}^{M} {‖ {\hat{q}}_{m} - R ( o ) * {\hat{d}}_{m} ‖}^{2} ) {\vert}_{o = {\hat{o}}_{i - 1}}$$

The convergence properties are the same as stated in one of the previous paragraphs.

In another embodiment, a method of improving accuracy of positioning and reporting in multipath transmission is described. Where there is no line-of-sight path, its extremely difficult to estimate the ToA, AoA and AoD precisely. However, the accuracy of these measurements may be drastically improved based on multipath positioning. The power delay profiles, and power angle profiles may contain information about the ToAs, AoAs and AoDs of multipath propagation paths. The estimated frequency domain channel, \hat{ }H is a complex tensor of dimension NFFT×Nr×Nt where, NFFT is the number of FFT points, Nr denotes the number of antenna elements at the receiver and Nt denotes the number of antenna elements at the transmitter. The estimated channel may be transformed to time and beam domain by taking DFT across time and angle domain respectively. The resultant 3D tensor may be passed to a convolutional neural network for accurate estimation of ToA, AoA and AoD and even E2E position estimation based on single and multiple base-station. The neural networks may be trained for single and joint parameter estimation.

In low complexity cases, the raw channel estimates may be passed to a Convolutional Neural Network (CNN) for training. In high accuracy scenarios, the channel estimates may be processed to reduce the effect of delay and angular spreading. The preprocessed channel estimates may be extremely sparse and require a much smaller CNN to achieve the same test accuracy compared to its un-preprocessed counterpart. The objective of preprocessing is to reduce the superposition of the sinc pulse in time and angle to the sum of time and angle-shifted impulses in 3D kernel. The time and angle shifts indicate the delays experienced and the angle of arrival or departure of all the significant multipaths.

In another embodiment, a method for the selection of a subset of accurate measurements for positioning a target node is described. While positioning a UE, a server may engage multiple base stations for either transmission or reception of reference signals. The receiver may report the measurement to the server. The server may use the measurements to compute the position of the target UE. However, some of the measurements may be erroneous due to the receiver's capabilities, state of the link (LoS/NLoS) to one or multiple paths, and UE's mobility. The erroneous measurements may often result in the degradation of the quality of estimates. Many of these estimates may be filtered out based on assistance information from transmitter and receiver. However, some of the measurements may be left unchecked and create outliers while computing the position of the target UE.

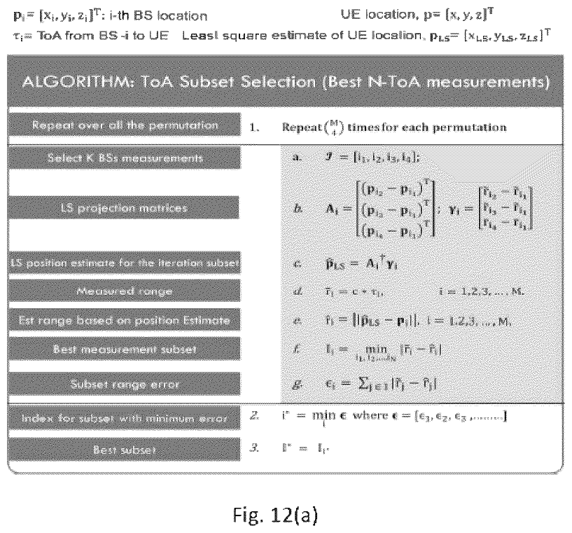

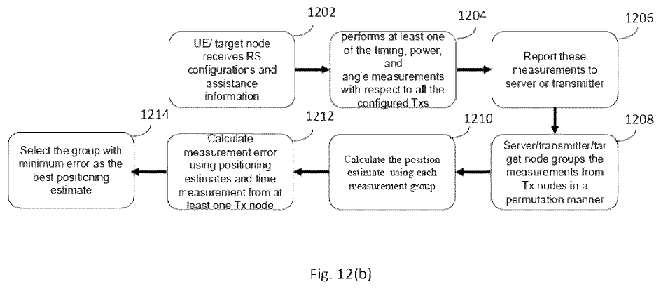

In wireless networks, multiple number (M) of BS may be engaged. Each of the M BSs may give out measurements for positioning the target node. However, a significant fraction of measurements from M BSs may be biased due to the aforementioned reasons. FIG. 12(a) illustrates an algorithm for the selection of N accurate measurements out of total M measurements from M BSs based on a minimum least square iterative procedure, in accordance with an embodiment of the present invention.

FIG. 12(b) illustrates a method for selection of group of accurate measurements, in accordance with an embodiment of the present invention. At step 1202, a first node (alternatively referred to as target node in the method described in FIG. 12(b)) may receive configuration information of at least one reference signal and at least one assistance information of a first path of plurality of paths from one or more second nodes. The target node and the second node may be one of a user equipment, a base station, and a relay node in the cellular network. At step 1204, the target node may perform measurement of at least one positioning parameters based on the configuration information from each of the one or more second nodes. The configuration information may include one or more of reference signal identifier and reference signal resources at different antenna on each antenna port of the one or more second nodes. The at least one positioning parameter include mobility parameter such as Doppler of at least one of a first arrival path and additional paths, power-based parameter such as total path power corresponding to LoS or NLoS paths, time positioning parameter such as time of arrival (ToA) and transmitter-receiver time difference of arrival of one or multiple paths, and angle positioning parameters such as Angle of Arrival from receiver (rx-AoA), Angle of Departure from transmitter (tx-AoD) from one or multiple paths. At step 1206, the target node may report the measurement of at least one positioning parameters to the one or more second node. At step 1208, one of the second node and the target node may group the measurement of at least one positioning parameter in a permutation manner. Each group of measurements may contain tuples of multiple measurements. In each tuple each measurement may be indexed by one or more base stations and/or target node identifier. Each measurement may also contain one or multiple of rx-AoA, tx-AoD, reference signal time difference (RSTD) measurement, ToA, and path-power (RSRP) with respect to one or more base stations and line of sight or non-line of sight paths. At step 1210, one of the second node and the target node may calculate an estimated position of the target node based on each group of measurements of the positioning parameters. At step 1212, one of the second node and the target node may calculate a measurement error in the estimated position of the target node based on at least one group of each group of measurement of the positioning parameters and measurement of time positioning parameter of the first path of plurality of paths. At step 1214, the group of measurements of the positioning parameters with a minimum error may be selected as best positioning measurements of positioning parameters for estimating position corresponding to different base stations. The group selected as best positioning measurements may indicate indices of base stations which are most likely to be line of sight base stations.

The target node may perform one or more of positioning using a group of measurements selected as the best positioning measurements, reporting measurements of positioning parameters to the second node for shortlisting the best measurements for performing one of positioning the target node or reporting the measurements to another node in the wireless network, and reporting the measurement selected as the best positioning measurements. The group of measurements may be reported by the target node with or without the corresponding measurements, base station identifier, angle measurements, RSRP measurements and path specific power to the base stations, location server, and other devices for sidelink scenarios. The method may further be extended to sidelink scenarios by replacing some or all with the assisting nodes and/or anchor UEs. Overhead in reporting of the measurements of the positioning parameters in each group of measurement may be reduced by reporting the measurements in an absolute manner, or in relative manner. In absolute manner, the measurements may be reported as it is. In relative manner, an operation 1 and operation 2 may be performed on measurements denoted by:
operation1(measurement-i, operation2 (measurement-1, measurement-2, . . . , measurement-L)),
where L denotes total group of measurements and i denotes a number of measurements from 1 to L, operation1 is an operator from a group of subtraction, addition, division, power, or multiplication of measurement-(i-1) with measurement-i or measurement-i with measurement-(i-1), and operation2(measurement-1, measurement-2, . . . , measurement-L) is an operator from a group of maximum, mean, median, mode, minimum of (measurement-1, measurement-2, . . . , measurement-L). Mathematical operators for operation1 and operation2 may be selected with an objective to minimize the reporting overhead.

In another embodiment, a method for selection of subset of accurate measurements for positioning a target node is described. In another embodiment, a method of optimizing measurement window of a target node where it is expected to receive one or more reference signal for determining positioning parameters is described. Rough position of the device may be estimated based on at least one positioning parameter including mobility parameter such as Doppler of at least one of a first arrival path and additional paths, power-based parameter such as total path power corresponding to LoS or NLoS paths, time positioning parameter such as time of arrival (ToA) and transmitter-receiver time difference of arrival of one or multiple paths, and angle positioning parameters such as Angle of Arrival from receiver (rx-AoA), Angle of Departure from transmitter (tx-AoD) from one or multiple paths from a receiver or a transmitter. Accuracy of positioning estimates depend on precision of measurements used for positioning. Prior measurements may be used for configuring measurement windows to the transmitter and the receiver for transmission and reception of reference signals for positioning. Configured windows may help the transmitter and receiver in reducing the transmission and measurement overhead related to positioning.

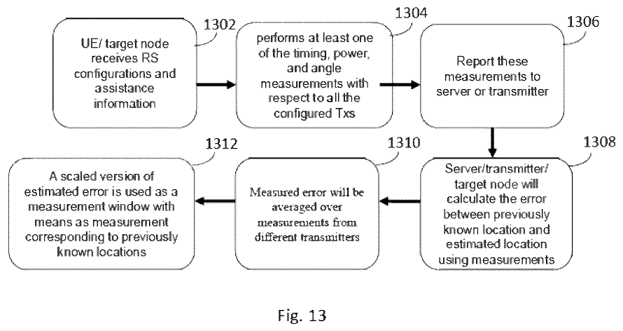

FIG. 13 illustrates a flowchart of a method of optimizing measurement window of a target node where the target node expects to receive one or more reference signal for determining positioning parameters, in accordance with an embodiment of the present invention. At step 1302, the first node (alternatively referred to as target node in the method described in FIG. 13) may receive a configuration information of at least one reference signal and at least one assistance information of a first path of plurality of paths from one or more second nodes. The second node may be one of a user equipment, a base station, and a relay node in the cellular network. At step 1304, the target node may perform measurement of at least one positioning parameters based on the configuration information from each of the one or more second nodes. At step 1306, the target node may report the measurement of at least one positioning parameters to the one or more second node. At step 1308, one of the second node and the target node may calculate a measurement error in estimated position of the target node based on the measurement of the positioning parameters received from the one or more second nodes and a previously known position of the target node. At step 1310, one of the second node and the target node may determine an average of measurement errors in estimated position of the target node. The average of measurement error scaled by a pre-defined factor and a mean value of the previously known position of the target node may be used to obtain a measurement window of estimation of position of the target node. At step 1312, the second node may configure the measurement window of estimation of position of the target node based on the previously known locations. In the measurement window the target node expects to receive one or more reference signal for determining positioning parameters. The measurement window may be one or more of time window and angle window based on the at least one positioning parameters and estimated position. The second node and the target node with information on one or more ToA estimates, rx-AoA estimates, tx-AoD estimates and cell geometry information including cell radius and cell boundary geolocation, may determine the measurement window.

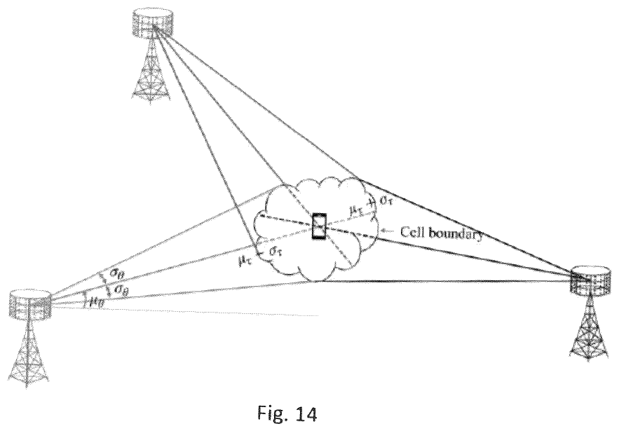

FIG. 14 illustrates calculation of time and angle windows for reception and transmission of reception signals. Based on the optimization criterion, an estimate of the position \hat{p}=[\hat{x},ŷ,\hat{z}]^{T} may be calculated. The optimization error with respect to each measurement may be calculated as follows:

$${\hat{τ}}_{i} = {‖ \hat{p} - {p}_{i} ‖}_{2} \\ {\hat{ϵ}}_{i} = c \times ( {\hat{τ}}_{i} - {\tilde{τ}}_{i} )$$

where \tilde{τ}ᵢ denotes the measured and \hat{ε}ᵢ ToA and is the estimated range error for a reference node-i.

$$( {μ}_{θ} , {μ}_{ϕ} ) = angle ( \hat{p} , {p}_{i} ) \\ {σ}_{θ} = {σ}_{ϕ} = α \times {tan}^{- 1} ( \frac{{\hat{ϵ}}_{i}}{c \times {\hat{τ}}_{i}} )$$

where α denotes scaling coefficient for windows. Scaling coefficient for windows may be decided based on the integrity of the measurements. Higher the integrity, the closer is the scaling coefficient to 1 and vice-versa.

Similarly, the time measurement window defined by mean ToA and standard deviation of ToA is calculated as follows:

$$mean ToA : {μ}_{τ} = {\hat{τ}}_{i} and \\ standard deviation of ToA : {σ}_{θ} = \vert {\hat{τ}}_{i} - {\tilde{τ}}_{i} \vert$$

The time window may be interpreted as follows:

If the reference signal (RS) is transmitted in time symbol-s of the time slot-n, then the receiver is expected to receive it in time symbols starting at lₛₜₐᵣₜ and end at time symbol l_{end} with respect to the time symbol when RS was transmitted from the transmitter.

$${l}_{start} = max \{ 0 , ⌈ \frac{{μ}_{T} - {σ}_{θ}}{{T}_{s}} ⌉ \} ; \\ {l}_{end} = {l}_{start} + max \{ {l}_{w , min ,} ⌈ \frac{2 \times {σ}_{θ}}{{T}_{s}} ⌉ \} ;$$

where is the l_{w,min} is the minimum size of the window supported by the receiver in time symbols and Ts is the time symbol duration.

The time windows may be computed either at the receiver or at the transmitter or at the location server (LS). Information required for calculating the angular and time windows may be collected at a destination node via relevant protocols. Once the time window parameters are calculated, the time window parameters may be shared with both the transmitter and/or receiver over the relevant channels or protocols based on the Quality of Service (QoS) required.

In uplink transmission, the transmitter may be a user equipment and receiver may be one of a serving base station, a primary base station, a secondary base station, and an anchor node in the cellular network. Similarly, in downlink transmission, the transmitter may be one of a serving base station, a primary base station, a secondary base station, and an anchor node and the receiver may be a user equipment in the cellular network. In both uplink and downlink transmission, the estimation of the measurement window may be shared with a transmitter and a receiver. The transmitter may use angle (AoD) measurement windows for transmit beamforming. The receiver may use the angle (AoA) measurement windows for receiver beamforming and receiver filtering, and time measurement windows for reserving resources for reference signal reception.

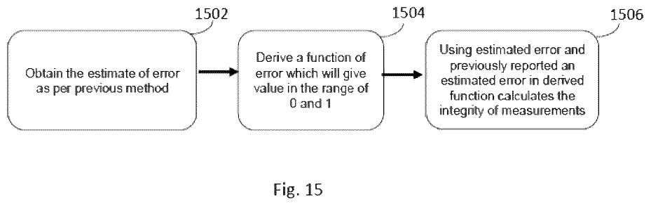

In another embodiment, the integrity of measurements may be calculated. FIG. 15 illustrates a method of integrity estimation, in accordance with an embodiment of the present invention. At step 1502, estimate of measurement error in estimated position may be obtained. At step 1504, a function of error may be derived based on the measurement error in estimated position of the target node based on the measurement of the positioning parameters received from the one or more base stations. The function may be in a range of 0 to 1. At step 1506, the derived function may be used to calculate integrity of measurements.

\hat{ϵ} denotes an optimization range error signifying trust in the measurements and how much these measurements complement each other. If the measurements don't satisfy each other then the optimization error will be high.

Integrity may be calculated based on the sigmoid of the optimization error as follows:

$$Integrity , ϛ = \frac{2}{1 + {e}^{\hat{ϵ}}}$$

where \hat{ϵ}=\hat{ϵ}₁, \hat{ϵ}₂, \hat{ϵ}₃, . . . ), and function ‘ƒ’ may be a statistical measure such as mean, median, mode etc. on application basis. After the target node is positioned, the integrity parameter is shared with the destination node that requested to locate the device.

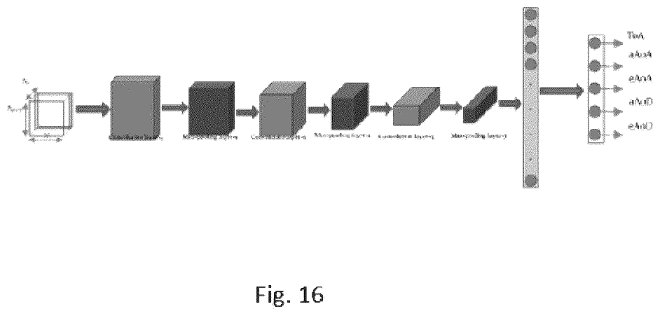

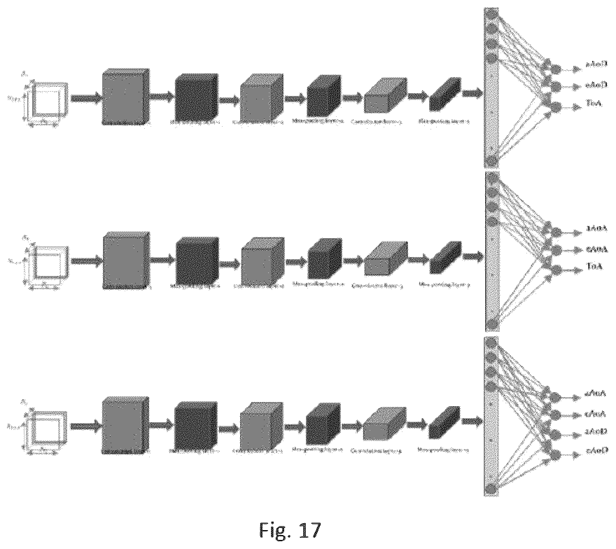

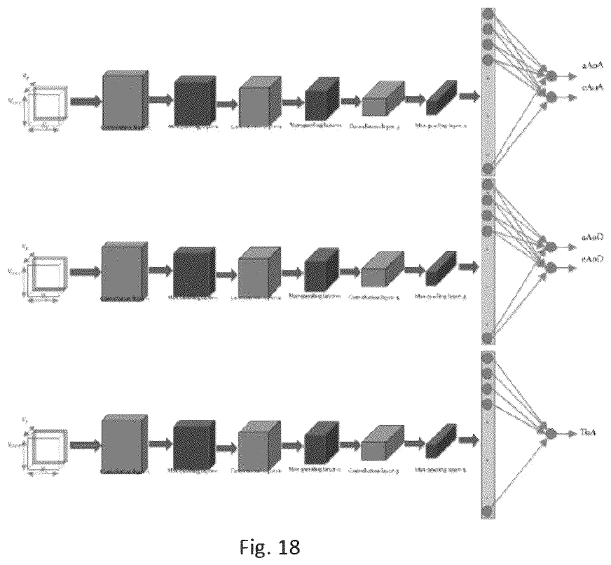

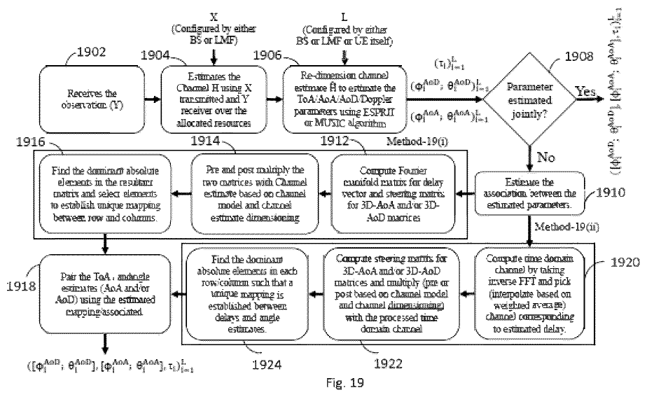

In another embodiment, positioning parameters such as AoA, AoD, and ToA may be estimated individually and/or jointly using neural networks in end-to-end fashion. The size of neural networks may be further reduced by doing the frequency and beam domain processing on the raw channel estimates and normalizing it. The neural networks may be trained exhaustively using a large channel data set for different terrains. Training of neural networks may be done in a site-specific and/or terrain-specific manner. FIG. 16 illustrates the joint estimation of AoA, AoD and ToA using neural network-based models, in accordance with an embodiment of the present invention. FIG. 17 illustrates the estimation of two measurements out of AoA, AoD and ToA using neural network-based models, in accordance with an embodiment of the present invention. FIG. 18 illustrates individual estimation of AoA, AoD and ToA using neural network-based models, in accordance with an embodiment of the present invention.

In many scenarios, especially in low and mid-frequency bands, it may not be possible to mitigate the NLOS bias completely but can surely be decreased by combining the timing (ToA/TDoA), angle (AoA-AoD) and power (RSRP) information. In methods for estimation of time of arrival, angle of arrival and angle of departure, the positioning parameters may be estimated jointly and others where the parameters are estimated individually. The joint estimation-based methods associate the timing, angle, and Doppler parameters automatically but have a high computational complexity and pose a huge pilot and measurement overhead. Hence, a method of estimation of time of arrival, angle of arrival, and angle of departure individually and then detecting the association between all positioning parameters is described. The association may be computed by deriving an inter-parameter correlation matrix using either one or both channel estimates and channel statistics. The positioning measurements are instigated by either the positioning server, user equipment or any other node in the network whose position is to be determined. Similarly, positioning server, user equipment or any other node in the network may provide a list of measurements to be estimated by the receiver. The positioning server may configure to report either ToA, AoA, AoD individually or a combination of them. These parameters may be reported for more than one multipaths as per configured by the positioning server. Similarly positioning configures the associated BS to transmit the reference signal to the UE for positioning measurements. UE or node configured for positioning receives the signal and perform the measurements.

A receiver may perform estimation of one or more positioning parameters ToA, AoA, AoD and Doppler for one or multiple paths. FIG. 19 illustrates a high accuracy method for measurement of inter-parameter association. At step 1902, the receiver may receive a signal denoted by a ninth equation,

$${YC}^{{N}_{r} \times {N}_{sc} \times {N}_{symb}}$$

In the ninth equation, Nᵣ denotes number of antennas at receiver, N_{sc} denotes number of subcarrier and N_{symb} denotes the number of OFDM symbols across time. The received signal Y is used to estimate the channel state information (CSI). Although, Y is sufficient to estimate ToA, AoA, AoD and Doppler, but the following explanations are based on the estimated channel state information (CSI). A transmitter may send a reference signal (X) for channel estimation at the receiver. The transmitter may be a base station or LMF. At step 1904, the receiver estimates the channel using the reference signal, or pilot signals, transmitted by the transmitter based on the configurations provided by the positioning server. Furthermore, the channel is interpolated for the resource elements where no reference signal, or pilot signal, is transmitted. The receiver may estimate CSI using X and Y received over the allocated resources. The CSI may be denoted by a tenth equation,

$$H ∈ {C}^{{N}_{r} \times {N}_{t} \times {N}_{s c} \times {N}_{symb}}$$

In the tenth equation, Nᵣ denotes number of antennas at receiver, N_{sc} denotes number of subcarrier, N_{symb} denotes the number of OFDM symbols across time and Nₜ denotes the number of antennas at the transmitter. The joint estimation of ToA, AoA, AoD and Doppler may be performed based on the subspace of \tilde{H}∈C^{N}^{ᵣ}^{×N}^{ₜ}^{×N}^{_{sc}}^{×(N}^{_{symb}}^{/N)} which is 2D-matrix form of multi-dimensional matrix H. The number of paths, L, may be estimated based on the significant Eigen values of the correlation matrix [symbol] _{H}=E[ [symbol] ^{H}] where E[⋅] operator is statistical expectation operator.

The re-dimensioned matrix [symbol] may be used for estimating the ToAs, AoAs, AoDs and Dopplers corresponding to each path and the association between each parameter may be established based on the simultaneous Schur decomposition (SSD). On the similar lines, the joint ToA-AoA-AoD, ToA-AoA, ToA-AoD, AoA-AoD and individual parameters ToA, AoA, AoD and Doppler may be estimated using \acute{H}C^{N}^{ᵣ}^{N}^{ₜ}^{N}^{_{sc}}^{×N}^{_{symb}}, \acute{H}C^{N}^{ᵣ}^{N}^{_{sc}}^{×N}^{ₜ}^{N}^{_{symb}}, [symbol] C^{N}^{ₜ}^{N}^{_{sc}}^{×N}^{ᵣ}^{N}^{_{symb}}, \acute{H}C^{N}^{ᵣ}^{N}^{ₜ}^{×N}^{_{sc}}^{N}^{_{symb}}, ȞC^{N}^{_{sc}}^{×N}^{ᵣ}^{N}^{ₜ}^{N}^{_{symb}}, \acute{H}C^{N}^{ᵣ}^{×N}^{_{sc}}^{N}^{ₜ}^{N}^{_{symb}}, \acute{H}C^{N×N}^{ₜ}^{N}^{_{sc}}^{N}^{ᵣ}^{N}^{_{symb}}^{/N} respectively.

The matrices \acute{H}, \acute{H}, [symbol] , \acute{H}, Ȟ, \acute{H}, \grave{H} ΛȞ are designed by restructuring H. The row dimension, dim₁, captures the information related to parameters of interest and column dimension, dim₂, provides diversity in measurements for subspace estimation. Mathematically, if dim₁>K*LΛK1 then all the parameters can be accurately estimated for all the paths. Higher the value of K, the better is the quality of parameters estimated using super-resolution methods. It was found that value of K equal to 4 is safe value for ESPRIT (Estimation of Signal Parameters via Rational Invariance Techniques) and MUSIC (Multiple Signal Classification) algorithms which estimate the parameters using signal and null or noise space, respectively.

Referring back to step 1906, the ToAs, AoAs and AoDs are estimated for each path using either MUSIC or ESPRIT algorithm at the receiver. At step 1908, after individual estimation of the one or more positioning parameters, at step 1910, an association between the one or more positioning parameters may be established based on snapshot correlation. The estimated CSI is reshaped into a matrix of size NₜNᵣ×N_{sc} and transformed into time domain CSI for further processing. In another embodiment, a method (19(i)) is illustrated. At step 1912, a steering vector are computed for all the, L², possible pairs of AoAs=[azimuth AoAs; elevation AoAs] and AoDs=[azimuth AoDs; elevation AoDs]. And a Fourier vector may be calculated for delay of each path. At step 1914, an association matrix may be computed. The association matrix may be the absolute value of time domain CSI matrix pre-multiplied by steering angle matrix and post multiplication with Fourier delay matrix. Mapping matrix helps in estimating the association between time and angle parameters. At step 1916, the mapping matrix is computed based on the dominating indices of the association matrix. In this process, the largest element of association matrix is picked, and the corresponding indices are set to 1 in mapping matrix. Subsequently, the next biggest element is selected, and indices are set to one in the mapping matrix provided that any element in the row or the column is not already set to one. However, if it is so, then this element is skipped, and next big element is taken, and the same process is repeated. At step 1918, the mapping matrix establishes the one-to-one correspondence between AoAs, AoDs and ToAs. This method is accurate but may have a high computational complexity.

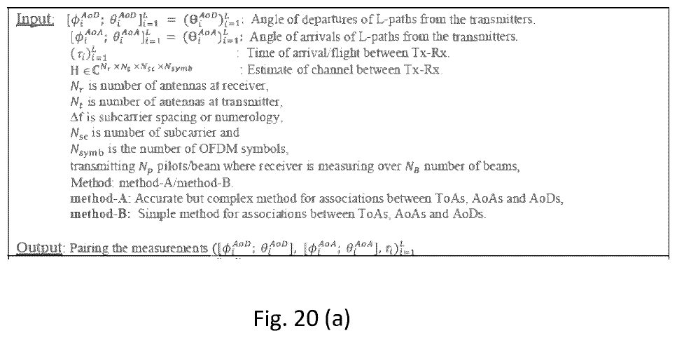

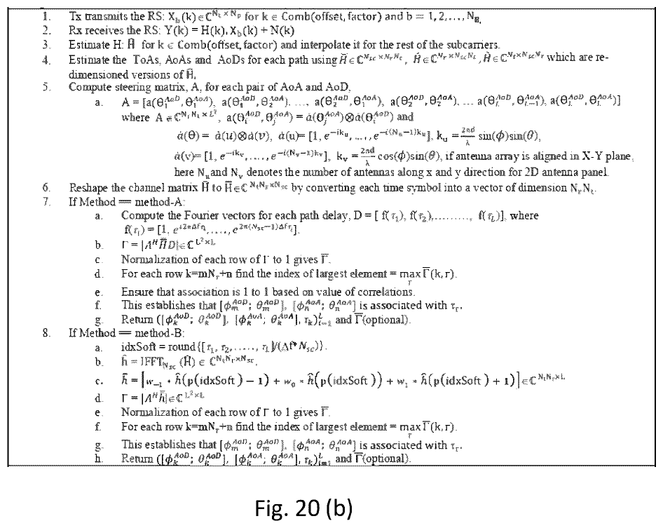

In another embodiment, a trade-off is offered complexity and accuracy by a method 19(ii). At step 1920, a time domain channel may be computed by taking the inverse Fourier transformation. The channel may be interpolated based on weighted average and selecting a channel corresponding to estimated delay. A closest time indices in time domain CSI corresponding to the ToAs. This association matrix is computed by taking the absolute value of time selected time domain CSI pre-multiplied by Steering angle matrix. At step 1922, a steering matrix for 3D-AoA and/or 3D-AoD matrices may be computed and multiplied (pre or post based on channel model and channel dimensioning) with the processed time domain channel. At step 1924, a mapping matrix based on step 616 may be calculated. The method ends at step 1918 with the mapping matrix establishing the one-to-one correspondence between AoAs, AoDs and ToAs. FIG. 20(a) illustrates an overall method of input of positioning parameters for estimation of association between the measurement of one or more positioning parameters. FIG. 20(b) illustrates describes detailed method A (denoted by method (19(i)) previously) and method B denoted by method (19(ii)) previously).

The above stated methods for path-power estimation are based on interpolation techniques. These methods though very simple may not be very accurate. Hence, an accurate method for path-power or path (Reference Signal Received Power) RSRP may be derived from the definition which is based on path delay. The path-power is defined as the power of a path in the channel impulse response which has been received at the receiver after a certain path-delay. If h(t) is a continuous channel impulse response for a link (between a transmit antenna and receive antenna), then the power of a path received after a certain path-delay delay path in is given by H(τₙ).

h(τₙ) may be computed as given in the eleventh equation:

$${\vert h ( {τ}_{n} / {T}_{s} ) \vert}^{2} = \frac{1}{N} {\vert {\sum }_{k = 1}^{{N}_{sc}} H [ k ] * {e}^{- \frac{j 2 π k {τ}_{n}}{{T}_{s} N}} \vert}^{2} = \frac{1}{N} {\vert {\sum }_{k = 1}^{{N}_{sc}} H [ k ] * {e}^{- j 2 π k {τ}_{n} Δ f} \vert}^{2}$$

In the above mentioned eleventh equation, where Tₛ is the sampling time and τₙ is the estimated delay for the certain path whose path-RSRP is being reported.

The definition of the path-RSRP is based on the delay of the path in CIR and captures the effect of reference signal bandwidth B=N·Δf where N is the number of FFT-point and Δf is the subcarrier spacing.

The definition may be further extended to time and angle domain based on the delay and beam-space (this dimension may capture AoA and AoD at the transmitter or the receiver) channel. Then power received over a 3D-channel h(τ, θ, Ø) where τ captures the delay experienced by a signal passing through this channel, θ captures the effect of AoA along elevation and azimuth angles and Ø denotes the azimuth and elevation angle of departure. The path-RSRP of a path arriving with delay τₙ from direction θₙ at receiver which departed from the BS from direction Øₙ is given by a twelfth equation

$${\vert h ( {τ}_{n} / {T}_{s} , {θ}_{n} / ( {O}_{r} {N}_{r} ) , {ϕ}_{n} / ( {O}_{t} {N}_{t} ) {‡}^{2} \frac{1}{N} \vert {\sum }_{k = 1}^{{N}_{sc}} {\sum }_{r = 1}^{{O}_{r} {N}_{r}} {\sum }_{t = 1}^{( {O}_{t} {N}_{t}} H [ k , r , t ] * {e}^{- \frac{j 2 π k {τ}_{n}}{{T}_{s} N}} {e}^{- \frac{j 2 π r {θ}_{n}}{{O}_{r} {N}_{r}}} {e}^{- \frac{j 2 π t {ϕ}_{n}}{{O}_{t} {N}_{t}}} \vert}^{2}$$

In case the channel information is available only along delay and AoA direction, the path RSRP of a path arriving with delay τₙ from direction θₙ at receiver is given by a thirteenth equation:

$${\vert h ( {τ}_{n} / {T}_{n} , {θ}_{n} / ( {O}_{r} {N}_{r} ) {‡}^{2} \frac{1}{N} \vert {\sum }_{k = 1}^{{N}_{sc}} {\sum }_{r = 1}^{{O}_{r} {N}_{r}} H [ k , r ] * {e}^{- \frac{j 2 π k {τ}_{n}}{{T}_{s} N}} {e}^{- \frac{j 2 π t {ϕ}_{n}}{{O}_{t} {N}_{t}}} \vert}^{2}$$

Similarly, in case the channel information is available only along delay and AoD direction, the path RSRP of a path arriving with delay τₙ which departed from the BS from direction Øₙ is given by a fourteenth equation:

$${{\vert h ( {τ}_{n} / {T}_{s} , {ϕ}_{n} / ( {O}_{t} {N}_{t} ) \vert}^{2} = \frac{1}{N} \vert {\sum }_{k = 1}^{{N}_{sc}} {\sum }_{t = 1}^{{O}_{t} {N}_{t}} H [ k , t ] * {e}^{- \frac{j 2 π k {τ}_{n}}{{O}_{r} {N}_{r}}} {e}^{- \frac{j 2 π t {ϕ}_{n}}{{O}_{t} {N}_{t}}} \vert}^{2}$$

Finally, the -RSRP of a path arriving from direction θₙ at receiver which departed from the path BS from direction Øₙ is given by a fifteenth equation:

$${{\vert h ( {θ}_{n} / ( {r}_{} ) , {ϕ}_{n} / ( {O}_{t} {N}_{t} ) \vert}^{2} = \frac{1}{N} \vert {\sum }_{r = 1}^{{O}_{r} {N}_{r}} {\sum }_{t = 1}^{{O}_{t} {N}_{t}} H [ k , r , t ] * {e}^{- \frac{j 2 π r {θ}_{n}}{{O}_{r} {N}_{r}}} {e}^{- \frac{j 2 π t {ϕ}_{n}}{{O}_{t} {N}_{t}}} \vert}^{2}$$

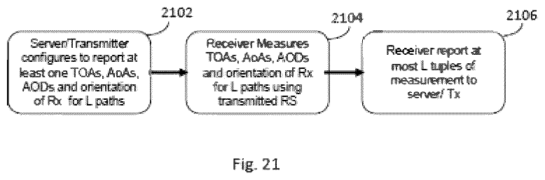

In another embodiment, a method for improving accuracy in multipath reporting is described. A receiver may estimate the positioning parameters such as ToAs, the AoAs, the receiver orientation and the AoDs of plurality wireless propagation paths. FIG. 21 illustrates a method for reporting measurement of positioning parameters of multipath, in accordance with an embodiment of the present invention. A plurality of wireless propagation paths may be denoted by a number “L”. The value of L may be signaled by one or multiple of the transmitters, positioning server, assisting node, anchor node or chosen by receiver itself. At step 2102, a second node (alternatively referred to as transmitter for the method described in FIG. 21) may configure a first node (alternatively referred to as receiver for the method described in FIG. 21) to report the positioning parameters estimated for “L” paths At step 2104, measurement of path specific positioning parameters such as path-specific power, path delay, path-AoA, path-AoD, path-Doppler, for one or few or all the paths may be reported for either each transmit-receive beam pair or group of transmit-receiver beam pair together. At step 2106, the receiver may report at most L tuples of measurements to the one or more of the serving BS, the primary BS, the neighboring BS and the anchor node. The location server may request the receiver to report number of measurements based on the QoS and positioning method. Each tuple of L tuples may contain at least one of ToA measurement, RSTD measurement, AoA measurement, AoD measurement, orientation measurement, AoD difference, and AoA difference. Different tuples may be allowed to report different set of measurement. Overhead in reporting of the tuples may be reduced by reporting the measurements in an absolute manner, or in relative manner. In absolute manner, the measurements may be reported as it is. In relative manner, an operation 1 and operation 2 may be performed on measurements denoted by:
operation1(measurement-i, operation2 (measurement-1, measurement-2, . . . , measurement-L)),
where L denotes total group of measurements and i denotes a number of measurements from 1 to L, operation1 is an operator from a group of subtraction, addition, division, power, or multiplication of measurement-(i-1) with measurement-i or measurement-i with measurement-(i-1), and operation2(measurement-1, measurement-2, . . . , measurement-L) is an operator from a group of maximum, mean, median, mode, minimum of (measurement-1, measurement-2, . . . , measurement-L). Mathematical operators for operation1 and operation2 may be selected with an objective to minimize the reporting overhead.

For neural network-based methods, the location server may request the UE to report [8 to NFFT] paths based on receiver capability. The reporting configuration may be provided by one of the BS or location server or the target node. The reporting configuration provided to receiver contains the information about which beams are to be reported together as a group, the directions the beams are to be received from, the number of measurements to be reported for first path and additional path based on accuracy requirement, the LOS indicator which could be a hard value {0 or 1} or a soft value between [0, 1], transmit-receive beam pair association. The indication about whether the receive beam direction is adjusted based on the UE orientation may be indicated. The beam directions or measurements are provided in co-ordinate system of either the serving BS or neighboring BSs or the global co-ordinate system. However, the indication of the co-ordinate system may be provided to the receiver by either the serving BS or the location server.

Similarly, the transmitter may be provided with the direction in which to transmit the beam. This direction window may be estimated based coarse location of the UE and coverage of the serving cell by a similar method of estimating time window and angle window as illustrated in aforementioned paragraphs.

In angle of departure-based positioning techniques, called DL-AoD in 5G-NR, the angle of departure is estimated based on the beam transmitted from the BS and power measured by the UE. In DL-AoD, if the AoD is estimated based on the direction of maximum power received, the accuracy will be limited by the number of beams transmitted and the resolution of beam transmission. The large number of transmitted beams cause huge measurement and reporting overhead which results in high power consumption and higher latency. This technique performs poorly as the measured power contained the contributions from the NLoS paths too. Hence its crucial to report power corresponding to LoS path alone. Present invention has proposed two methods to improve the performance of angle of departure-based methods.

In one embodiment, a high accuracy angle of departure-based positioning techniques is described. The receiver estimates the channel based on the reference signal transmitted by the transmitted for each beam and estimate power delay profile. The transmitted reference signal may be positioning reference signal (PRS), synchronization reference signal block (SSB), sounding reference signal (SRS) etc.

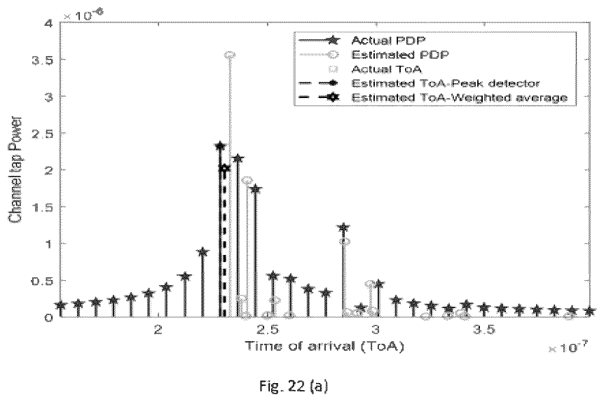

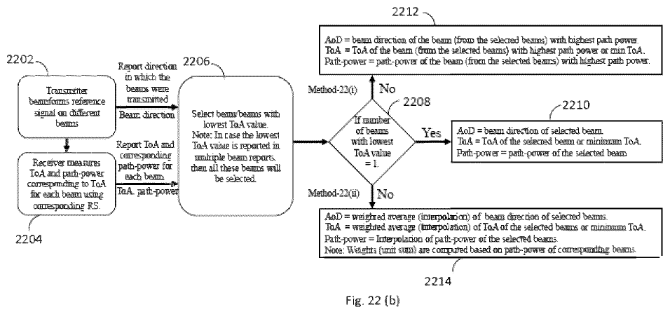

FIG. 22(a) illustrates a power delay profile of a channel between transmitter (with 64 antennas) and receiver (with 1 antenna) for Indoor factory-sparse high scenarios. As illustrated in FIG. 22(a), the receiver first finds the first peak in the power delay profile followed by the interpolation of power at a finer granularity between the sample before the peak sample and the one next to the peak sample.

FIG. 22(b) illustrates a low complexity method of estimation of positioning parameters (ToA and AoD) based on beam direction. The peak of the power delay profile may be considered for the estimation of value of ToA based on the sampling rate. At step 2202, a transmitter transmits a reference signal beamformed on one or more beams. The Transmitter reports the direction in which the one or more beams are transmitted to a destination node. The destination node may be a transmitter, receiver or a positioning server. At step 2204, the receiver estimates a time positioning parameter (ToA) and the path-power corresponding to the time positioning parameter (ToA) for each of the one or more beams using a corresponding reference signal. The Receiver reports the time positioning parameter (ToA) and the path-power corresponding to the time positioning parameter (ToA) for each of the one or more beams to the destination node. At step 2206, the destination node selects the one or more beam with lowest value of the time positioning parameter ToA. At step 2208, the destination node determines if the number of beams with lowest value of the time positioning parameter (ToA) is one. If the number of beams with lowest value of ToA is one then at step 2210, then the time positioning parameter (ToA), an angle positioning parameter (AoD) and the path power is estimated based on the selected beam. The location server contains, say Pr number of, (Power, ToA, AoD) pairs where the (Power, ToA) is reported by UE and AoD is reported either by the transmitter or the receiver for every beam transmitted. The server sorts the reports in the order of increasing ToA and then selects the pairs with lowest ToA. The AoD of this pair is selected as AoD of LoS path.

FIG. 22(b) further illustrates a sub-method of estimation of positioning parameters based on beam direction (22(i)). An interpolated channel corresponding to the ToA may be used for AoD estimation. The receiver converts the interpolated channel snapshot into beam domain channel by pre-multiplying it with the oversampled DFT matrix. The AoD is estimated based on the angle, or index, that results in the peak in the power of beam domain channel. An enhanced ToA, power corresponding to the ToA in power delay profile and AoD is reported to the positioning server. Referring back to step 2208, in one embodiment, on determination of more than one beams with the lowest value of the time positioning parameter ToA, at step 2212, the destination node estimates the time positioning parameter (ToA) for positioning a user equipment based on the ToA corresponding to the beam with highest path power from the selected beams, the angle positioning parameter (AoD) for positioning a user equipment based on the transmit beam direction with highest power from the selected beams, and the path power as the power received on the beam with the highest path power from the selected beams.

FIG. 22(b) further illustrates a method (22(ii)) of estimation of positioning parameters. In one embodiment, where the receiver does not perform estimation of angle of departure and reports ToA and power to the positioning server, the method (22(ii)) may be used. Referring back to step 808, in one embodiment, on determination of more than one beams with the lowest value of the time positioning parameter (ToA), at step 2214, the destination node estimates the time positioning parameter (ToA) for positioning a user equipment based on a weighted average of the ToA of the selected beams, the angle positioning parameter (AoD) for positioning a user equipment based on a weighted average of beam direction of selected beams and, the path power as the interpolation of the path-power of the selected beams. The weights in the weighted average are assigned based on the path-power of corresponding beams. The method (22(ii)) may be used where the positioning server collects the AoD measurements from the transmitter who estimates the AoD either based on the reciprocity or based on the transmit beam directions. The method (22(ii)) often results in better AoD accuracy.

The method of estimation of positioning parameters (ToA and AoD) based on beam direction may be implemented at the transmitter or positioning server provided the CSI information is available at these nodes. Moreover, the method as illustrated in FIG. 22 may be used for any number of antennas at the receiver and transmitter. Further, the method as illustrated in FIG. 8 may be implemented at the server and also at the transmitter, provided the CSI information is available at these nodes. The method as illustrated in FIG. 22 may be extended to estimate the ToA, AoA and AoD of any number of paths that appear in the power delay profile (PDP) of the estimated wireless channel. Table 4 illustrates improved AoD estimation based on weighted average. Table 4 describes method A denoted by method (22(i)) and method B denoted by method (22(ii).

Input:([ϕᵢ^{AoD}; θᵢ^{AoD}], powᵢ, τᵢ¹)._{i =1}^{N}^{_{B}}
ϕᵢ^{AoD}; θᵢ^{AoD} denote the azimuth and elevation angle of departure of the transmit beam-i.
powᵢ denote the power of the first tap recieved by the receiver over the transmit beam-i.
τᵢ¹ denote the ToA of first tap reveived by the reveiver over the transmit beam-i.
Method = method-1: direction/beam from to maximum power reveived by UE.
Method = method-2: weighted average of the directions having lowest time of flight.
Output: AoD estimates: ([ϕ_{LoS}^{AoD}; θ_{LoS}^{AoD}]).

| | |
|---|---|
| 1. | $I = {max}_{r} {τ}_{r}^{1} .$ |
| 2. | N_{K} = cardinality(l); |
| 3. | If N_{K} = = 1 then |
| | a. [ϕ_{LoS}^{AoD}; θ_{LoS}^{AoD}]) = [ϕ_{I(1)}^{AoD}; θ_{I(1)}^{AoD}] |
| | b. Return [ϕ_{LoS}^{AoD}; θ_{LoS}^{AoD}] |
| 4 | If Method = = method-A |
| | $a . k = {max}_{i} {\{ {pow}_{i} \}}_{i ∈ I}$ |
| | b. Return [ϕₖ^{AoD}; θₖ^{AoD}]. |
| 5. | ${w}_{j} = \frac{{pow}_{j}}{{\sum }_{i = 1}^{{N}_{K}} {pow}_{i}}$ |
| 6. | [ϕ_{LoS}^{AoD}; θ_{LoS}^{AoD}]) = Σᵢ₌₁^{N}^{_{K}}(wᵢ * [ϕᵢ^{AoD}; θᵢ^{AoD}]); where Σᵢ₌₁^{N}^{_{K}}wᵢ = 1. |
| 7. | Return [ϕ_{LoS}^{AoD}; θ_{LoS}^{AoD}]. |

The method as illustrated in FIG. 22 is simple and fast and overcomes the challenge of limited accuracy of ToA estimate especially for inverse fourier transformation based ToA estimation which utilizes the estimate of PDP. The accuracy of ToA is limited by bandwidth. Referring back to FIG. 21, due to finite bandwidth the taps expand into sinc pulses and many times close by taps superimposes resulting into larger peaks making it more difficult to segregate them in time domain. This phenomenon, as illustrated in FIG. 22(a), displaces the peaks and reduces the accuracy of ToA estimates. In such cases, also, the method as illustrated in FIG. 22 utilizing weighted average of peak tap and its adjacent taps based on their power improves the accuracy of ToA estimates.

In another embodiment, a low complexity method of estimation of positioning parameters (ToA and AoD) based on channel estimation is given. A channel is estimated based on the reference signal beamformed by the transmitter. The AoD may be estimated either using the channel estimates available at the receiver or the channel estimates reported to either BS or positioning server. The AoD is estimated using the channel estimates using either ESPRIT or MUSIC algorithm. If the AoD is estimated at the receiver, the receiver reports the power, ToA, and AoD to the positioning server where it is combined with beam information reported by the transmitter to refine the AoD estimates. In another scenario, the positioning server may process the CSI estimates and beam information, reported by the transmitter, together to estimate the AoD precisely.

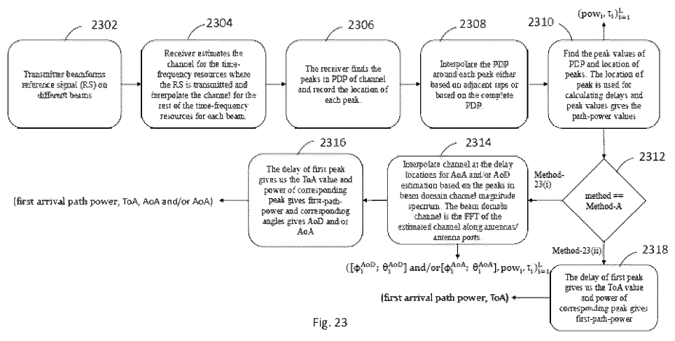

FIG. 23 illustrates the low complexity method of estimation of positioning parameters (ToA and AoD) based on channel estimation. As illustrated in FIG. 23, at step 2302, the transmitter beamforms a reference signal on different beams to the receiver. At step 2304, the receiver estimates a channel based on a reference signal received on the allocated time-frequency resources and interpolates the channel for the time-frequency resources where the RS is not transmitted for each beam. At step 2306, the receiver finds and records location of each peak in the power delay profile (PDP) of the channel. At step 2308, the receiver interpolates the PDP around each of the one or more peaks based on adjacent paths or based on the entire PDP. At step 2310, the receiver determines the values and the locations of the one or more peaks in the PDP. The values of the peaks are used for determination of path-power and the location of the one or more peaks is used for calculation of delay.

In another embodiment, a method (23(i)) is utilized. At step 2312, it is determined by the receiver if the method (23(i)) is to be performed. If yes, then at step 2314, the receiver interpolates a channel at the delay locations for one or more angle positioning parameters AoA and AoD estimation based on the peaks in a beam domain channel magnitude spectrum. The beam domain channel is a Fourier transformation of the estimated channel along one or more antenna ports. At step 2316, the positioning server for estimation of a time positioning parameter ToA based on the delay of first peak, the one or more angle positioning parameters AoA and AoD and first path-power based on the power of corresponding peak. In another embodiment, a method (23(it)) is described wherein, at step 2318, the positioning server estimates time positioning parameter ToA based on the delay of first peak and the first path-power based on the power of corresponding peak. The server processes the CSI estimates and beam information, reported by the transmitter, together to estimate the AoD precisely. Table 5 illustrates a method based on AoD estimation and improved ToA estimation based on inverse fourier transformation (IFFT). Table 5 describes method A denoted by method (23(i)) and method B denoted by method (23(i)).

| | |
|---|---|
| Input: | Tx have Nₜ antennas, |
| | Rx have Nᵣ antennas with ODFM system having N_{sc} subcarriers, |
| | transmitting Nₚ pilots/beam where receiver is measuring over N_{B} number of beams, |
| | Method: method-A/method-B. |

Output: ToA estimate, Power estimate, AoD estimates: ([ϕ_{LoS}^{AoD}; θ_{LoS}^{AoD}]).

| | |
|---|---|
| 1. | Tx transmits the RS:X_{b}(k) ∈ [symbol] ^{N}^{ₜ} ^{× N}^{ₚ} for k ∈ Comb(offset, factor) and b = |
| | 1, 2,..., N_{B}. |
| 2. | Rx receives the RS: Y(k) = H(k)·X_{b}(k) + N(k) |
| 3. | Estimate H: Ĥ for k ∈ Comb(offset, factor) and interpolate it for the rest of the |
| | subcarriers. |
| 4. | ĥ = IFFT_{N}_{_{sc}} (Ĥ) ∈ [symbol] ^{N}^{_{sc}} ^{× N}^{ₜ}. |
| 5. | p = Findpeak (\|\|ĥ\|\|²), where p is vector containing peaks in the power delay profile |
| | and norm is taken antenna dimension. |
| 6. | ToA = (w₋₁ * (p(1) − 1) + w₀ * p(1) + w₁ * (p(1) + 1))/(N_{sc} * Numerlogy), |
| | where w₋₁ + w₀ + w₁ = 1. |
| 7. | Pow = (interpolate (\|ĥ\|²) at w₋₁ * (p(1) − 1) + w₀ * p(1) + w₁ * (p(1) + 1)) |
| 8. | If Method == method-A |
| | c.AoD = Findhighestpeak{FFT_{N}_{ₜ}[w₋₁ * ĥ(p(1) − 1) + w₀ * ĥ(p(1)) + |
| | w₁ * ĥ(p(1) + 1)]} |
| | d. Return (ToA, Pow, AoD). |
| 9. | Return (ToA, Pow). |

In another embodiment, a signaling method for ToA is given,
1) The receiver reports the sample-power of the set of indices to one or multiple of the, except itself
   a) The UE,
   b) The serving BS,
   c) The primary BS,
   d) The location server,
   e) The anchor/assisting node.
2) The set of indices is one of the following:
   a) Indices of all the samples (complete CSI).
   b) Indices around a particular sample (a particular path).
   c) Indices around a group of samples (multiple paths).

In this case, the set of samples are reported as follows:
i) Multiple groups of equal or unequal length are reported.
ii) The number of groups and number of samples per group are decided one or multiple of the UE, the serving_BS, the primary BS, the anchor node, the assisting node and the location server.
iii) This information is configured to the receiver.

In another embodiment, a signaling method for ToA is given as,
1) The receiver reports at least one of the first arrival path-power, RSRP and FAP-ToA FAP-AoA, FAP-AoD, Rx orientation along with the corresponding Tx and Rx beam ID(s) to one or multiple of the, except itself:
   a) The UE,
   b) The serving BS,
   c) The primary BS,
   d) The location server,
   e) The anchor/assisting node.
2) The transmitted reports the Tx-ID(s) and their corresponding beam directions to one or multiple of the following, except,
   a) The UE,
   b) The serving BS,
   c) The primary BS,
   d) The location server,
   e) The anchor/assisting node.
3) The destination is required with the Tx beam direction and associated RSRP or FAP-RSRP.

Both these information can be extracted either from
a) The receiver report alone.
b) Jointly from transmitter and receiver report based on the reliability of the measurements reported
   i) Tx beam direction from Tx report.
   ii) Received RSRP or received FAP-RSRP from the receiver report.
4) The reliability of the measurements and state of the link is computed based the additional measurement reported such as:
   a) Rx AoA, Rx orientation, Tx AoD for link state prediction (LoS/NLoS link).
   b) FAP-AoA, Rx orientation, FAP-AoD/Tx Beam direction and FAP-ToA for best beam/best measurement selection.

In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

1. A method for identifying position of a node in a wireless communication system, the method comprising:
receiving, by at least one first node, information of number of antennas and antenna ports available at least one second node;
determining, by the at least one first node, at least one antenna group of at least one of the at least one first node and the at least one second node based on the number of antennas and antenna ports configured at the at least one first node and the at least one second node;
signaling, by the at least one first node to the at least one second node, at least one of configuration information of at least one reference signal and at least one assistance information;
receiving, by the at least one second node, the at least one of configuration information of the at least one reference signal, the at least one antenna group, and the at least one assistance information transmitted by the at least one first node;
transmitting, by the at least one first node, the at least one reference signal over the at least one antenna group; and
receiving, by the at least one second node, the at least one reference signal transmitted by the at least one first node, using the configuration information,
wherein the at least one second node estimates at least one positioning parameter for at least one of a first arrival path and additional paths based on the at least one reference signal.

2. The method as claimed in claim 1, wherein one of the at least one first node and the at least one second node is a user equipment, a base station, and a relay node, in a cellular network.

3. The method as claimed in claim 1, wherein the number of antenna groups is given by
$$\frac{{N}_{t \vert r}}{{N}_{ap , t \vert r}} ,$$
where N_{t|r} denotes number of antennas at the at least one first node or the at least one second node, N_{ap,t} denotes number of antenna ports at the first node, and N_{ap,r} denotes number of antenna ports supported by the second node and an operator on division applied is a ceil operator.

4. The method as claimed in claim 3, wherein the at least one reference signal is transmitted over the at least one antenna group for the number of antenna group times in a time division multiplex manner.

5. The method as claimed in claim 1, wherein the configuration information includes at least one of reference signal identifier and reference signal resources of at least one antenna group of the at least one first node.

6. The method as claimed in claim 1, wherein the assistance information includes at least one of information about antenna beam, antenna array configuration information, and multiplexing information of the at least one antenna port.

7. The method as claimed in claim 6, wherein the antenna array configuration information includes at least one of the antenna placement geometry, antenna panel information, and antenna geometry parameters.

8. The method as claimed in claim 7, wherein the antenna placement geometry is at least one of rectangular array, elliptical array, and cylindrical array.

9. The method as claimed in claim 8, wherein the antenna geometry parameters for rectangular array are at least one of vertical and horizontal spacing, number of elements per panel, number of panels in horizontal directions, number of panels in vertical direction, and polarization.

10. The method as claimed in claim 8, wherein the antenna geometry parameters for elliptical arrays are at least one of the radial distances and number of antenna elements across each radial direction.

11. The method as claimed in claim 8, wherein the antenna geometry parameters for cylindrical arrays are at least one of the radial distances, number layers, and number antenna elements in each layer.

12. The method as claimed in claim 1, wherein the at least one estimated positioning parameter is used to estimate position of the at least one second node.

13. The method as claimed in claim 1, further comprising reporting by the at least one second node, one of the at least one estimated positioning parameter and estimated position of the at least one second node based on the at least one positioning parameter, to at least one of a location server or the at least one first node.

14. The method as claimed in claim 1, wherein the at least one positioning parameter comprises time positioning parameters, angle positioning parameters, mobility based parameters, and power based measurements and wherein the time positioning parameters include at least one of Time of Arrival (ToA), time difference of arrival (TDOA), and transmitter-receiver time difference of arrival, the angle positioning parameters include Angle of Arrival from receiver (s-AoA) from the at least second node and Angle of Departure from the at least one first node (f-AoD), the mobility based parameters include Doppler of at least one of the first arrival path and the additional paths and the power based measurements include total path power corresponding to line of sight or non-line of sight paths.

15. A method for identifying position of a node in a wireless communication system, the method comprising:
receiving, by at least one first node, information of number of antennas and antenna ports available at least one second node;
determining, by the at least one first node, at least one antenna group of at least one of the at least one first node and the at least one second node based on the number of antennas and antenna ports configured at the at least one first node and the at least one second node;
signaling, by the at least one first node to the at least one second node, at least one of configuration information of at least one reference signal and at least one assistance information; and
transmitting, by the at least one first node, the at least one reference signal over the at least one antenna group.

16. The method as claimed in claim 15, wherein one of the at least one first node and the at least one second node is a user equipment, a base station, and a relay node, in a cellular network.

17. The method as claimed in claim 15, wherein the number of antenna groups is given by
$$\frac{{N}_{t \vert r}}{{N}_{ap , t \vert r}} ,$$
where N_{t|r}, denotes number of antennas at the at least one first node or the at least one second node, N_{ap,t} denotes number of antenna ports at the first node, and N\vec{ap,r} denotes number of antenna ports supported by the second node and an operator on division applied is a ceil operator.

18. The method as claimed in claim 17, wherein the at least one reference signal is transmitted over the at least one antenna group for the number of antenna group times in a time division multiplex manner.

19. A method for identifying position of a node in a wireless communication system, the method comprising:
receiving, by at least one first node, at least one of an initial estimated position of a target node used for positioning, a measurement of at least one of time positioning parameter, and a first angle positioning parameter, from the at least one second node, wherein the time positioning parameter is at least one of Time of Arrival (ToA) and time difference of arrival (TDOA) and the first angle positioning parameter is Angle of Departure from the at least one first node (f-AoD);
receiving, by the at least one first node, a measurement of a second angle positioning parameter (s-AoA) from the at least one second node, wherein the second angle positioning parameter is Angle of Arrival of the at least one second node (s-AoA);
determining, by the at least one first node, a rotation matrix using the at least one of the time positioning parameters, the first angle positioning parameters, the initial estimated position of the at least one second node, and the second angle positioning parameter, wherein the rotation matrix provides rotation of the at least one second node with respect to the reference for positioning at the at least one first node.

20. The method as claimed in claim 19, wherein the at least one second node performs a measurement of the second angle positioning parameter.

21. The method as claimed in claim 19, wherein determining the rotation matrix by the at least one first node comprises:
initializing, the orientation vector with one of a rough estimate, random values, and all zero;
estimating the rotation matrix using orientation vector;
estimating a direction vector wherein the direction vector is a difference of location estimate of the at least one second node and the location of the at least one first node;
determining the estimated projection vector as product of distance and unit direction vector, wherein the distance is estimated using TOA and unit direction vector is estimated using f-AOD estimate; and
updating the rotation matrix using retraction of previous rotation matrix estimate with weighted projection of previous rotation matrix onto the outer product of estimate of error in direction vector and local direction vector, wherein the error in the direction vector is difference in the estimate of the direction vector, computed using the first angle of departure and time of arrival, and dot product of previous rotation matrix and the local direction vector estimated using the second angle positioning parameter (s-AoA),
wherein the rotation matrix is updated until a predefined criteria is satisfied.

22. The method as claimed in claim 19, wherein an orientation vector of the at least one second node is determined using the rotation matrix.

23. The method as claimed in claim 22, wherein determining the orientation vector by the at least one first node comprises:
initializing, the orientation vector with one of, rough estimates of value, random values, and all zero;
estimating the rotation matrix using orientation vector;
determining a direction vector estimate which is a difference of location estimate of the target node and the location of the at least one first node;
determining an estimated projection vector as a product of distance and the unit direction vector, wherein the distance is estimated using TOA estimate and the unit direction vector is estimated using f-AOD; and
updating the orientation vector using gradient of the difference of the estimated projection vector and measured projection vector, wherein the measured projection vector is the product of the rotation matrix estimate and the direction vector estimate,
wherein the orientation vector is updated until a predefined criteria is satisfied.

24. The method as claimed in claim 19, wherein one of the at least one first node and the at least on second node includes at least one of a user equipment, base station, and a relay node.

25. The method as claimed in claim 19, wherein a value of the measurement of the second angle positioning parameter (s-AoA) is a function of a local co-ordinate system.

26. The method as claimed in claim 19, wherein a value of the measurement of the first angle positioning parameter (f-AoD) and the time positioning parameter are a function of a global co-ordinate system.

27. The method as claimed in claim 19, wherein the initial estimated position of the at least one second node is reported along with at least one of an integrity and a time stamp of measurement.

28. A method for identifying position of a node in a wireless communication system, the method comprising:
receiving, by the at least one first node, a measurement of at least one positioning parameter from an at least one second node;
grouping, by the at least one first node, at least one positioning parameter in a permutation manner;
calculating, by the at least one first node, an estimated position of the at least one second node based on each group of the at least one positioning parameter;
calculating, by the at least one first node, an optimization error in an estimated position of the at least one second node over each group of the at least one positioning parameter; and
selecting the group of the at least one positioning parameter with a minimum optimization error as best group of positioning parameters for estimating position.

29. The method as claimed in claim 28, wherein the at least one positioning parameter comprises time positioning parameters, angle positioning parameters, mobility based parameters, and power based measurements, and wherein the time positioning parameters include at least one of Time of Arrival (ToA), Time Difference of Arrival (TDOA) and transmitter-receiver time difference of arrival for one or multiple paths, the angle positioning parameters include at least one of the Angle of Arrival from second node (s-AoA) and Angle of Departure from the first node (f-AoD) for one or multiple paths, the mobility based parameters include Doppler of at least one of the first arrival path and additional paths, and the power based measurements include total path power corresponding to line of sight or non-line of sight paths.

30. The method as claimed in claim 28, wherein the one of at least one first node and the at least one second node is one of a user equipment, base station, and a relay node, in a cellular network.

31. The method as claimed in claim 28, wherein the configuration information includes at least one of reference signal identifier and time-frequency resources of reference signal of the at least one second node.

32. The method as claimed in claim 28, wherein the measurement of the at least one positioning parameters includes measurement of the at least one positioning parameter indexed by a corresponding identifier of the at least one of, the at least one first node, and the second node.

33. The method as claimed in claim 28, wherein each group of measurement of positioning parameters includes tuples of the at least one positioning parameters indexed by a corresponding identifier of at least one of the at least one second node and the at least one first node.

34. A method for identifying position of a node in a wireless communication system, the method comprising:
receiving, by an at least one second node, configuration information of an at least one reference signal and an at least one assistance information;
performing, by the at least one second node, a measurement of an at least one positioning parameter based on the configuration information from the at least one first node,
grouping, by the at least one second node, at least one positioning parameter in a permutation manner;
calculating, by the at least one second node, an estimated position based on each group of the at least one positioning parameter;
calculating, by the at least one second node, an optimization error in an estimated position over each group of the at least one positioning parameter; and
selecting a group of the at least one positioning parameter with a minimum optimization error as a best group of positioning parameters for estimating the position.

35. The method as claimed in claim 34, wherein the at least one second node performs one or more of:
positioning using the measurements of group of measurement selected as the best group of at least one positioning parameter;
reporting the measurements of positioning parameters to the at least one first nodes for selecting the best group of at least one positioning parameter for performing one of the positioning of the at least one second node or reporting the measurements of the best group of at least one positioning parameter to another node in the wireless network; and
reporting the measurements selected as the best group of positioning measurements.

36. The method as claimed in claim 34, wherein the measurement of the at least one positioning parameters in each group is reported in a relative manner after performing mathematical operation on measurements to reduce overhead in reporting.

37. The method as claimed in claim 34, wherein the mathematical operation is one of subtraction, addition, division, power, and multiplication of the at least one measurement with one of maximum, mean, median, mode, and minimum of the at least one measurement.

38. The method as claimed in claim 34, wherein the at least one positioning parameter comprises time positioning parameters, angle positioning parameters, mobility based parameters, and power based measurements, and wherein the time positioning parameters include at least one of Time of Arrival (ToA), Time Difference of Arrival (TDOA) and transmitter-receiver time difference of arrival for one or multiple paths, the angle positioning parameters include at least one of the Angle of Arrival from second node (s-AoA) and Angle of Departure from the first node (f-AoD) for one or multiple paths, the mobility based parameters include Doppler of at least one of the first arrival path and additional paths, and the power based measurements include total path power corresponding to line of sight or non-line of sight paths.

39. The method as claimed in claim 34, wherein one of at least one first node and the at least one second node is a user equipment, base station, and a relay node, in a cellular network.

40. The method as claimed in claim 34, wherein the configuration information includes at least one of a reference signal identifier and time-frequency resources of a reference signal of the at least one second node.

41. The method as claimed in claim 34, wherein the measurement of the at least one positioning parameters includes measurement of the at least one positioning parameter indexed by a corresponding identifier of the at least one of, the at least one first node, and the second node.

42. The method as claimed in claim 34, wherein each group of measurement of positioning parameters includes tuples of the at least one positioning parameters indexed by a corresponding identifier of at least one of the at least one second node and the at least one first node.

43. A method for identifying position of a node in a wireless communication system, the method comprising:
reporting, by at least one second node, measurement of at least one positioning parameter to at least one first node;
calculating, by one of the at least one first node and the at least one second node, at least one of an average and a standard deviation of measurement of the at least one positioning parameter; and
determining, by one of the at least one first node and the at least one second node, a measurement window for the at least one second node using at least one of the average and the standard deviation of the measurement of the at least one positioning parameter.

44. The method as claimed in claim 43, wherein the standard deviation is scaled by a predefined positive value.

45. The method as claimed in claim 43, wherein determining the measurement window comprises: configuring, by the at least one first node, the measurement window for estimating position of the at least one second node, and wherein the at least one second node is expected to receive at least one reference signal for determining the at least one positioning parameter.

46. The method as claimed in claim 43, wherein the measurement window is at least one of time window and angle window based on the at least one positioning parameter and the estimated position.

47. The method as claimed in claim 43, wherein the at least one positioning parameter comprises time positioning parameters, angle positioning parameters, mobility based parameters, and power based measurements, and wherein the time positioning parameters includes at least one of Time of Arrival (ToA), Time Difference of Arrival (TDOA), and transmitter-receiver time difference of arrival, the angle positioning parameters includes Angle of Arrival (s-AoA) from the at least second node and Angle of Departure from the at least one first node (f-AoD), the mobility based parameters includes Doppler of at least one of the first arrival path and the additional paths and the power based measurements include total path power corresponding to line of sight or non-line of sight paths.

48. The method as claimed in claim 43, wherein the measurement window is determined with information on the at least one of ToA estimates, s-AoA estimates, f-AoD estimates, and cell geometry information including cell radius and cell boundary geolocation.

49. The method as claimed in claim 43, wherein the measurement window is signalled to one of the at least one first node and the at least one second node.

50. The method as claimed in claim 43, wherein the at least one first node and the at least one second node are one of a user equipment, base station, and a relay node, in a cellular network.

51. The method as claimed in claim 47, wherein the at least one first node uses angle (AoD) measurement windows for transmit beamforming.

52. The method as claimed in claim 47, wherein the at least one second uses the angle (AoA) measurement windows for receiver beamforming and receiver filtering, and time measurement windows for reserving resources for reference signal reception.

53. The method as claimed in claim 43, wherein the configuration information includes at least one of reference signal identifier and time-frequency resource of reference signal of the first node.

54. The method as claimed in claim 43, wherein calculating the standard deviation of the measurement of the at least one positioning parameter further comprises, estimating the integrity of measurement of the at least one positioning parameter using a first predefined function of the measurement error in at least one positioning parameter of the at least one second node, and calculating a value in a range of 0 to 1 using a second predefined function.

55. The method as claimed in claim 54, wherein the first predefined function is one of the maximum, minimum, mean, median, mode, and weighted mean.

56. The method as claimed in claim 54, wherein the second predefined function is one of sigmoid function and hyperbolic tangent function.

57. A method for identifying position of a node in a wireless communication system, the method comprising:
receiving a configuration by at least one second node, a reference signal for reporting at least one positioning parameter for a plurality of paths to at least one first node;
receiving, by the at least one second node, the reference signal for reporting the at least one positioning parameter for a plurality of paths;
estimating, by the at least one second node, positioning parameters for the plurality of paths using the received reference signal; and
reporting, by the at least one second node, at least one path positioning parameter to the at least one first node,
wherein the at least one path positioning parameter is one of path delay, path angle, path Doppler, path phase, and path power.

58. The method as claimed in claim 57, wherein the path power is defined as an absolute value of the sum of the product of channel at subcarrier with an exponential function of subcarrier spacing and path delay.

59. The method as claimed in claim 57, wherein a path of the plurality of paths is a trajectory followed by the transmitted signal while propagating over wireless channel before reaching the receiver.

60. The method as claimed in claim 57, wherein the at least one positioning parameter includes at least one of the time positioning parameters, angle positioning parameters, mobility based parameters, and power based measurements, and wherein the time positioning parameters includes at least one of Time of Arrival (ToA), Time Difference of Arrival (TDOA), and transmitter-receiver time difference of arrival, the angle positioning parameters includes Angle of Arrival (s-AoA) from the at least second node and Angle of Departure from the at least one first node (f-AoD), the mobility based parameters include Doppler of at least one of the first arrival path and the additional paths and the power based measurements includes total path power corresponding to line of sight or non-line of sight paths, and orientation of the target node, for each of the plurality of paths.

61. The method as claimed in claim 57, wherein the at least one first node and at least one second node is one of a user equipment, a base station, and a relay node, in a cellular network.

62. The method as claimed in claim 57, wherein a number of the plurality of paths is signaled to the at least one first node by the at least one second node or indicated by least one first node.
